(19) United States
(12) Patent Application Publication
(10) Pub. No.: US 2012/0259876 A1
(43) Pub. Date: Oct. 11, 2012

(54) Database for Managing Contracts were Multiple Existing or Expiring Contracts are Replaced with a Combined Contract

(76) Inventors: Aji K. Mathai, Santa Clara, CA (US); Aloke Bhatnagar, Campbell, CA (US); Ashish Agarwal, San Jose, CA (US); David Nano, San Jose, CA (US); Ricardo D. Cortes, Los Gatos, CA (US); Sean K. Smith, San Francisco, CA (US); Tak M. Leung, Milpitas, CA (US)

(21) Appl. No.: 13/528,539

(22) Filed: Jun. 20, 2012

Related U.S. Application Data
(63) Continuation-in-part of application No. 11/622,923, filed on Jan. 12, 2007.
(60) Provisional application No. 60/800,843, filed on May 15, 2006.

(51) Int. Cl. G06F 17/30

(52) U.S. Cl. 707/756; 707/E17.009

(57) ABSTRACT

Methods and systems for managing media distribution are disclosed. Advantageously, the management of media distribution can be substantially computer implemented and include management of media distribution agreements. The management of media distribution agreements can operate to manage the replacement of media distribution agreements in an automated and efficient manner. The methods and systems for management of media distribution can take appropriate action when one or more prior existing media distribution agreements are to be replaced with a replacement media distribution agreement for any of a variety of reasons.

### CROSS-REFERENCE TO RELATED APPLICATIONS

This application is a Continuation-In-Part of U.S. patent application Ser. No. 11/622,923, filed Jan. 12, 2007, and entitled “COMPUTERIZED MANAGEMENT OF MEDIA DISTRIBUTION AGREEMENTS”, which is hereby incorporated herein by reference, which in turn claims priority of U.S. Provisional Patent Application No. 60/800,843, filed May 15, 2006, and entitled “TECHNIQUES AND SYSTEMS FOR ELECTRONIC SUBMISSION OF MEDIA CONTENT”, which is hereby incorporated herein by reference.

### BACKGROUND OF THE INVENTION

Traditionally, music has been purchased at music stores or music departments of larger stores. A consumer will visit the music store or department and manually browse for albums or compact discs (CDs) of interest. Often, the music in the music store or department is categorized by genre, and then indexed by artist. For example, genre can include rock, country, pop, soul, jazz, etc. After the consumer selects an album or CD of interest, the consumer proceeds to a check-out register to pay for the album or CD being purchased.

In recent years, music delivery or distribution over the Internet has become popular. Due to the advances in efficient file formats, such as MP3 and MPEG4, the size of media files have become small enough to make their download via the Internet practical. Also, technological advances have led to higher-speed Internet connections and lower cost of memory. The combination of these advances make downloading media files, such as for music and videos, manageable and not too time consuming.

Today, various online media distribution sites permit virtual visitors to electronically search or browse various media items (e.g., albums, songs, ring tones, videos, etc.) as well as purchase and download such media items via the Internet (e.g., World Wide Web). However, in order for the media items to be offered for purchase and download, the electronic content for the media items must first be provided to the media distribution sites. Conventionally, content providers enter into contracts (i.e., legal agreements) with media distribution sites so that media items of the content providers can be offered for purchase and download at the media distribution sites. Unfortunately, many media distribution sites do not provide robust contract management systems to manage these contracts. For example, contracts may expire and not be timely replaced. Manual interaction may then be required to cease the purchase and download of media items corresponding to content providers having expired contracts. These and other problems are exacerbated by the large number of content providers that distribute media content in various countries with media distribution sites. As a result, representatives of the media distribution site face substantial burdens and difficulties in attempting to manage the contracts associated with the many content providers and across many different countries.

Thus, there is a need for improved approaches to manage contracts governing distribution of media items from online media distribution sites.

### SUMMARY

Methods and systems for managing media distribution are disclosed. Advantageously, the management of media distribution can be substantially computer implemented and include management of media distribution agreements. The management of media distribution agreements can operate to manage the replacement of media distribution agreements in an automated and efficient manner. The methods and systems for management of media distribution can take appropriate action when one or more prior existing media distribution agreements are to be replaced with a replacement media distribution agreement for any of a variety of reasons, including newer version, consolidation, expanded scope, etc.

The invention can be implemented in numerous ways, including as a method, system, device, apparatus, graphical user interface, or computer readable medium. Several embodiments of the invention are discussed below.

As a computer-implemented method for automated processing of media contracts for a media distribution system, one embodiment can, for example, include at least: storing at least one prior existing media contract in a database; receiving a media contract replacement request from a media content provider to replace the at least one prior existing media contract with a replacement media contract, the replacement media contract having a scope of agreement that is expanded beyond that of the at least one prior existing media contract being replaced; determining a document set, by a contract management system operating on a server computer, to be utilized for the replacement media contract; dynamically and automatically personalizing the document set by the contract management system for the media content provider; and sending the personalized document set for the replacement media contract to the media content provider.

As a media management system for managing distribution of media content, one embodiment can, for example, include at least an agreement management system performed by at least one computing device, and a media distribution system coupled to the agreement management system. The agreement management system can be configured to: manage media distribution agreements, store agreement information of the media distribution agreements in a database, determine whether to replace at least one prior existing media distribution agreement with a replacement media distribution agreement, the replacement media distribution agreement being for a media content provider and having a scope of agreement that is expanded beyond that of the at least one prior existing media distribution agreement being replaced, and dynamically and automatically personalize the replacement media distribution agreement for the media content provider. The media distribution system is coupled to the agreement management system that manages electronic distribution of media content associated with media content providers to purchasers over a network.

As a non-transitory computer readable medium including at least computer program code stored on thereon for processing of media distribution agreements between a media content provider and a media distribution system, one embodiment can, for example, include at least: computer program code for receiving an agreement replacement request from a media content provider to replace first and second prior existing media distribution agreements with a replacement media distribution agreement; computer program code for determining the replacement media distribution agreement to be utilized for the agreement replacement request; computer program code for personalizing the replacement media distribution agreement for the media content provider; and computer program code for providing the personalized replacement media distribution agreement to the media content provider.

Other aspects and advantages of the invention will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, wherein like reference numerals designate like structural elements, and in which:

FIG. 1A is a block diagram of a media submission and distribution system according to one embodiment.

FIG. 1B is a block diagram of a media management system according to one embodiment.

FIG. 1C is a schematic diagram of a contract database organization according to one embodiment.

FIG. 2A is a flow diagram of a contract delivery process according to one embodiment.

FIG. 2B is a flow diagram of a contract completion process according to one embodiment.

FIG. 3A illustrates an exemplary e-mail message that can be sent to a content provider (i.e., user) to invite the content provider to apply for usage of the media distribution system.

FIG. 3B illustrates an exemplary contract request screen according to one embodiment.

FIG. 3C illustrates a representative e-mail message that can be sent to a content provider when they are approved for a new contract (e.g., media distribution agreement).

FIGS. 3D and 3E illustrate a representative e-mail message sent to a content provider.

FIG. 4 is a flow diagram of a contract renewal notification process according to one embodiment.

FIG. 5A is a diagram of a retrieval notification system according to one embodiment.

FIG. 5B is a flow diagram of a renewal notification process.

FIG. 6A is an exemplary e-mail message that can be sent to a content provider (i.e., user) to inform them that one or more of their existing contracts are due to expire in several months.

FIG. 6B is an exemplary contract renewal screen according to one embodiment.

FIG. 6C is an exemplary contract amendment screen according to one embodiment.

FIGS. 7A and 7B are flow diagrams of a contract renewal process according to one embodiment.

FIG. 8 is an exemplary e-mail message that can be sent to a content provider (i.e., user) to inform them that one or more of their existing contracts has been successfully renewed.

FIG. 9A is a simplified example of a media contract replacement request screen.

FIG. 9B is a simplified example of a counterpart screen to the media contract replacement request screen shown in FIG. 9A

FIG. 10A is another simplified example of another media contract replacement request screen.

FIG. 10B is a simplified example of a counterpart screen to the media contract replacement request screen shown in FIG. 10A.

FIG. 11 is a flow diagram of a contract replacement notification process according to one embodiment.

FIGS. 12A and 12B are flow diagrams of a contract replacement process according to one embodiment.

### DETAILED DESCRIPTION OF EMBODIMENTS OF THE INVENTION

Methods and systems for managing media distribution are disclosed. Advantageously, the management of media distribution can be substantially computer implemented and include management of media distribution agreements. The management of media distribution agreements can operate to manage the replacement of media distribution agreements in an automated and efficient manner. The methods and systems for management of media distribution can take appropriate action when one or more prior existing media distribution agreements are to be replaced with a replacement media distribution agreement for any of a variety of reasons, including newer version, consolidation, expanded scope, etc.

Users can interact online with the contract management system to create or replace contracts. In one embodiment, the contracts being managed pertain to media content that is being made available for distribution, such as by an online media distribution system (e.g., online media hosting site). Management of the contracts in an automated manner facilitates automated control over submission and/or distribution of media content with respect to the online media distribution system.

In one embodiment, the contracts being managed can be media contracts, i.e., contracts that concern media content. The media content being governed by such contracts can, for example, be text, audio, video, and/or image data. More generally, as used herein, contracts are legal agreements between parties (e.g., a content provider and a media content distributor/media distribution system). Hence, the contracts can also be referred to herein as agreements (e.g., media distribution agreements).

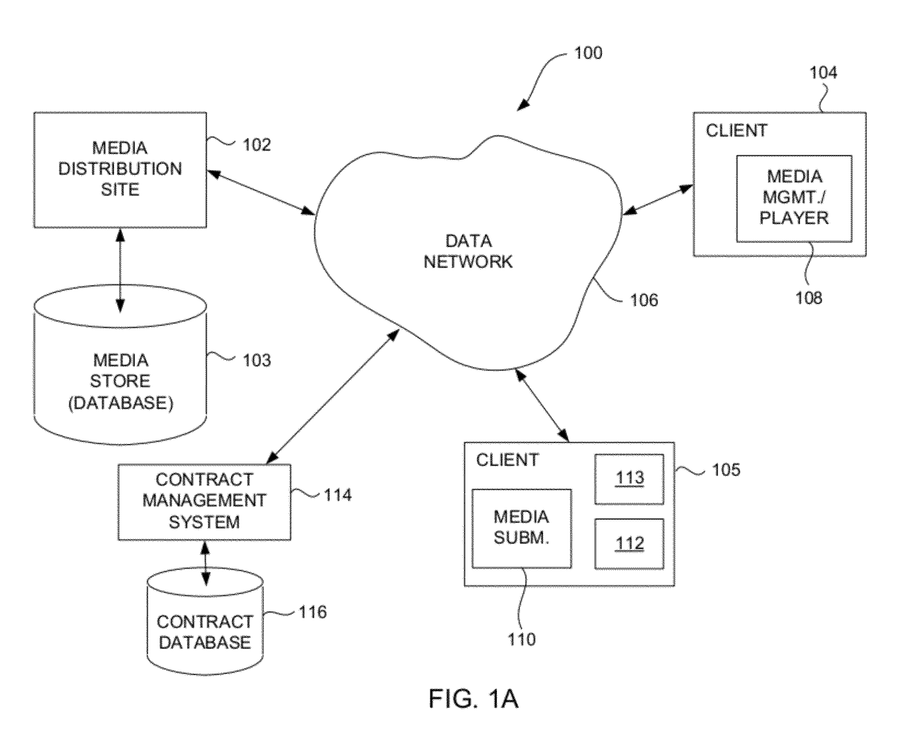

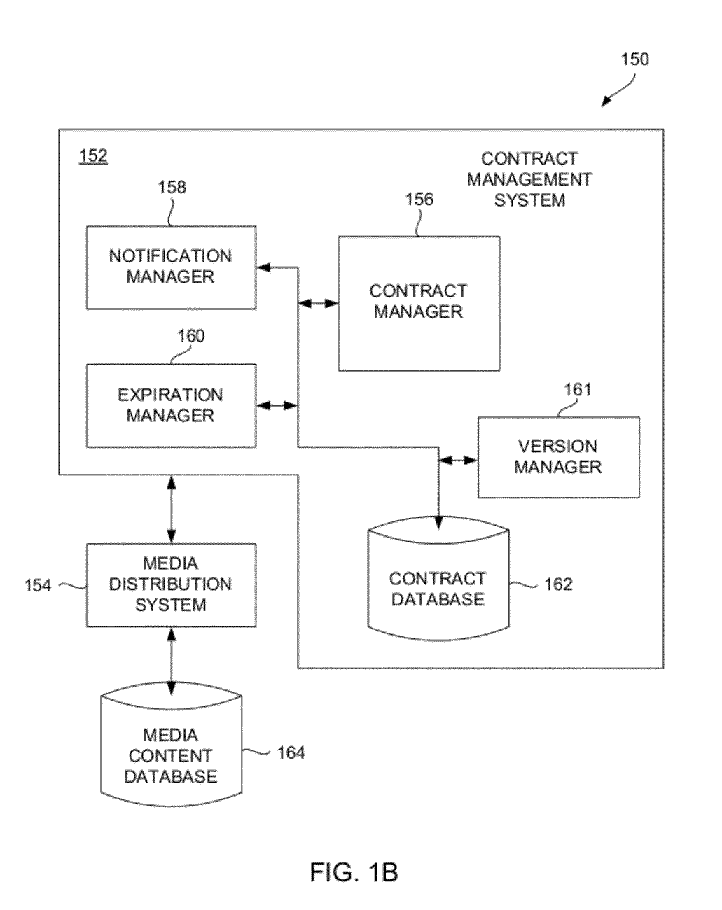

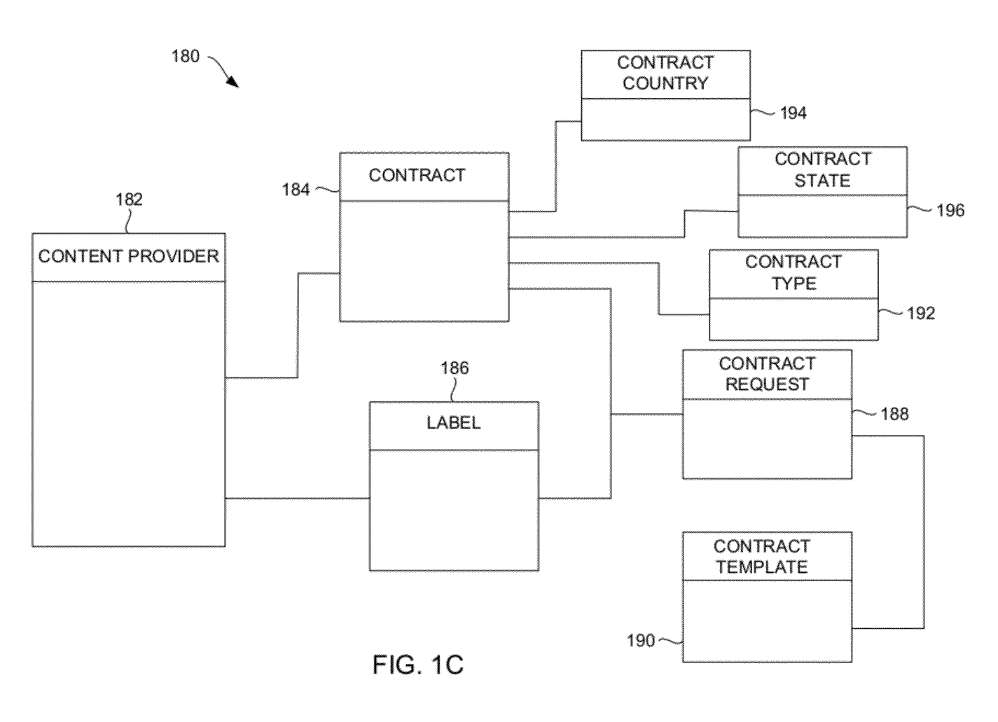

Embodiments of various aspects of the invention are discussed below with reference to FIGS. 1A-12B. However, those skilled in the art will readily appreciate that the detailed description given herein with respect to these figures is for explanatory purposes as the invention extends beyond these limited embodiments.

A media submission and distribution system can provide contract management. The contract management can assist with contract formation, contract replacement and/or contract renewal. The ability to submit media and/or distribute media can also be dependent on contract status. For example, media submission and/or distribution can be automatically authorized or declined depending on contract status.

FIG. 1A is a block diagram of a media submission and distribution system 100 according to one embodiment. The media submission and distribution system 100 includes a media distribution system 102. The media distribution system 102 coordinates submission (receipt), storage and purchase of media items. The media distribution system 102 stores media items in a media store 103. In one embodiment, the media store 103 is a database (media database). The media store 103 provides mass storage of the numerous media items that are available for purchase. Once purchased, the media items can be accessed from the media store 103 over a data network 106 by way of the media distribution system 102.

The media submission and distribution system 100 also includes a first client 104 and a second client 105. Typically, the media submission and distribution system 100 would include a plurality of different clients 104, 105. The first client 104 includes a media management/player 108 for playing and/or managing media items. The second client 105 includes a media submission program 110 for submitting media items to the media distribution system 102. Some clients can also include both the media management/player 108 and the media submission program 110. The media management/player 108 is an application program (e.g., software application) that operates on the first client 104, which is a computing device. One example of a suitable media management/player 108 is iTunes® offered by Apple Computer, Inc. The first client 104 is coupled to the media distribution system 102 through the data network 106. Hence, any of the first clients 104 can interact with the media distribution system 102 to review, purchase and/or manage media items. The client 105 can also include a network browser 112 and an electronic mail program 113.

The media submission program 110 is also an application program (e.g., software application) that operates on the second client 105, which is a computing device. The media submission program 110 is used to submit media items to the media distribution system 102. Additional information on media submission programs is provided in U.S. patent application Ser. No. 11/609,815, filed Dec. 12, 2006, and entitled “TECHNIQUES AND SYSTEMS FOR ELECTRONIC SUBMISSION OF MEDIA FOR NETWORK-BASED DISTRIBUTION,” now U.S. Pat. No. 7,844,548, which is hereby incorporated herein by reference.

Although the media management/player 108 and the media submission program 110 are shown in FIG. 1A as separate programs, it should be understood that such programs can be integrated into a single program and reside on the same client.

In the media submission and distribution system 100 shown in FIG. 1A, the media items are submitted to the media distribution system 102 by way of the media submission program 110. The media distribution system 102 can pertain to a media distribution site (or online media hosting site).

The media items that have been submitted (e.g., via the second client 105) are processed and then stored in the media store 103. Thereafter, the stored media items are available to be purchased from the media distribution system 102. Upon purchasing a particular media item, the media distribution system 102 permits the media content for the particular media item to be retrieved from the media store 103 and then delivered (e.g., downloaded) from the media distribution system 102 to the corresponding client 104 through the data network 106. In this regard, the media distribution system 102 obtains the media content corresponding to the particular media item from the media store 103 and transmits (e.g., downloads) such content through the data network 106 to the client 104. The downloaded media content can then be stored on the client 104. In one embodiment, the downloaded media content is encrypted as received at the client 104 but is decrypted and then perhaps re-encrypted before persistent storage on the client 104. Thereafter, the media management/player 108 can present (e.g., play) the media content at the client 104.

The media submission and distribution system 100 allows a user of the client 104 to utilize the media player 108 to browse, search or sort through a plurality of media items that can be purchased from the media distribution system 102. The media management/player 108 may also allow the user to preview a media item. In the event that the user of the media management/player 108 desires to purchase a particular media item, the user (via the media management/player 108) and the media distribution system 102 can engage in an online commerce transaction in which the user pays for access rights to the particular media item. In one embodiment, a credit card associated with the user is credited for the purchase amount of the particular media item.

The submission and purchase of the media items can be achieved over a data network 106. In other words, the submission and purchase of the media items can be achieved online. The purchase of media items online can also be referred to as electronic commerce (e-commerce). In one embodiment, the data network 106 includes at least a portion of the Internet. The clients 104 can vary with application but generally are computing devices that have memory storage. Often, the clients 104 are personal computers or other computing devices (media players, Portable Digital assistants (PDAs), mobile phones, etc.) that are capable of storing and presenting media to their users.

The connections through the data network 106 between the media distribution server 102 and the clients 104, 105 can be through secure connections, such as Secure Sockets Layer (SSL). Further, the media content can be re-encrypted prior to storage at the client 104 such that downloaded media content is not stored in the clear, but is instead stored in an encrypted manner.

The media submission and distribution system 100 further includes a contract management system 114. The contract management system 114 couples to the data network 106. The contract management system 114 also has access to a contract database 116. The contract management system 114 provides management of contracts for the media distribution system 102. The client 105 can interact with the contract management system 114 via the data network 100 so as to request a new contract for media submission or to renew an existing contract pertaining to media submission. The renewal of an existing contract can involve a newer version of the contacts, or can involve a replacement agreement that has an expanded scope (e.g., in terms of content types or geographical regions). A content provider can communicate with the contract management system 114 via the client 105 through use of the network browser 112 or the media submission program 110.

The media submission and distribution system 100 allows content providers to submit media to the media distribution system 102. In this regard, the media submission program 110 operating on the client 105 can submit media content to the media distribution system 102 over the data network 106. The media distribution system 102 interacts with the contract management system 114 for various reasons. One reason is that the media distribution system 102 verifies that the media (media content) being submitted to the media distribution system 102 is done so by an authorized content provider. Being authorized means that the content provider is under an existing media distribution agreement (i.e., contract) with the media distribution system 102. The contract management system 114 stores information concerning media contracts for all authorized content providers of the media distribution system 102. Hence, the media distribution system 102 can interact with the contract management system 114 to determine whether a content provider seeking to submit media content to the media distribution system 102 is authorized. In one embodiment, authorization of a content provider can be dependent on the type of content that the content provider seeks to submit. When the content provider is determined not to have an existing media contract for distribution of media, the media distribution system 102 can decline to distribute any media content provided by the content provider. Moreover, the media distribution system 102 can decline to accept receipt of any of media content whose submission is being attempted by the content provider.

The media distribution system 102 and the contract management system 114 can be provided on the same or different server computers. Indeed, in one embodiment, the media distribution system 102 and the contract management system 114 can be integrated together. Regardless of whether the media distribution system 102 and the contract management system 114 are provided on the same or different computers, the combination of the media distribution system 102 and the contract management system 114 can be referred to as a media management system.

The media distribution system 102 can serve a wide range of geographic territories. In the case of media content, there are often separate rights for different territories. For example, one party may own the rights for media distribution in United States, where another party may own the rights for media distribution in China. Still further, the media distribution system 102 may operate to distribute various different types of media. For example, the media distribution system 102 (e.g., an online media store) can offer for sale music (songs or albums), audiobooks, music videos, videos, audiobooks, games, etc. As such, the contract management system 114 according to one embodiment can separately manage the contract rights in different regions or territories as well as for different media content types. The contract management system is largely automated by the contract management system 114.

A contract request process according to one embodiment of the invention can be described as follows. Initially, a user, such as a label (e.g., music label), can be invited to interact with the contract management system 114 so as to create an account and request a contract. If approved, the contract management system 114 will produce a contract and transmit it to the user. Once the contract is signed and returned, and the user receives final approval, the user is permitted to submit content to the media distribution system 102. Methods and systems for submitting content to the media distribution system 102 were discussed above. The digital content that is submitted is then made available for distribution in those territories under which the user (e.g., label) is under contract.

When a user (e.g., label) is creating an account, an online form can be utilized to receive data from the user, who is now an applicant. The network address for the online form can be provided to the applicant via e-mail. For example, the e-mail message can include a link that pertains to a uniquely encrypted URL. As the applicant enters data into the online form, the data can be captured electronically by the system and stored at the server in a database. The data can subsequently be used to minimize the data entry required by the applicant for subsequent documents, such as contracts. After the account is created, the applicant can request to enter a contract. If the media distribution system 102, or a digital content distributor associated with the media distribution system 102, approves the applicant for a contract, contract documents can be dynamically generated by the system and then transmitted to the applicant. The applicant can then sign and return the contracts by regular mail, electronic mail, facsimile, electronically, etc. The contract information is also stored in the database. For example, the contract information can include (i) content types that the contract is associated with, (ii) territories, (iii) pricing tier, (iv) expiration date, (v) mechanicals (i.e., royalties), (vi) start date, and the like. Once the signed contract is received by the digital content distributor/media distribution system 102, the contract can undergo a business and/or legal review. The applicant can also undergo a financial review, e.g., so that a financial account in a financial system (e.g., SAP) can be configured to track royalties that are associated with the digital content. Regardless of the various reviews, once the contract is approved, the content provider can be permitted to upload media content to the digital content distributor in accordance with their contract.

Accordingly, when digital content is submitted for distribution by a content provider, the digital content is verified to be under an existing contract between the content provider (submitter) and the digital content distributor. In the event that the digital content is not deemed to be under an existing contract, the digital content will not be made available for distribution at the media distribution system 102. This normally requires access to the contract database 116 that stores the contract information. In this regard, availability of digital content for distribution may in some cases be frequently checked; hence, it may be advantageous to cache certain database information so that the checks are able to be performed rapidly and without needing to access the database on a frequent basis.

Given that contract information is stored within the contract database 116, the contract management system 114 can also monitor contracts to ensure that they remain updated. In other words, when existing contracts are near their expiration date, the contract management system 114 can take appropriate action to notify the content providers (e.g., labels) that their contracts will soon expire. The distribution of the digital content associated with the content provider can be automatically restricted or prevented in the event that a content provider's contract associated with such content expires. Hence, the contract management system 114 can remind content providers that they needed to renew their contract in order for their content to continue to be available for distribution. In the event that a content provider desires to renew their contract, they can interact via an online means with the contract management system 114 to request and receive a renewed contract. The renewed contract can be electronically transmitted to the user, such as in PDF format.

In general, the contract management system 114 can monitor and determine when to seek renewal of existing contracts, whether agreements are in effect with particular content providers, and what regions content providers are authorized to distribute (i.e., sell) in, and what types of content the content providers are authorized to distribute.

FIG. 1B is a block diagram of a media management system 150 according to one embodiment. The media management system 150 includes a contract management system 152 and a media distribution system 154. The contract management system 152 manages creation and renewal of media contracts for numerous different providers of media content. The contract management system 152 can also be used to assist with the approval of contracts, determining whether media content is under contract, etc. The contract management system 152 includes a contract manager 156 that manages creation/renewal of media contracts. The contract manager 156, the notification manager 158, the expiration manager 160 and a version manager 161 can all access a contract database 162. The contract database 162 can store descriptive information concerning the media contracts. The contract information can include start date, expiration date, content provider, media type, contract status, a version number, etc.

After initial contracts have been set up with content providers, at some point these contracts will expire. Since the contract database 162 maintained by the contract management system 152 stores information on expiration dates of the various contracts, the contract management system 152 is aware of when contracts will expire for particular content providers. As a result, the media management system 150 can also monitor contract expiration and manage contract renewal. Further, new media contract versions may become available. The new media contract versions may be more recent than versions of the initial contracts that have been set up with content providers. Since the contract database 162 maintained by the contract management system 152 stores information on version numbers of the various contracts, the contract management system 152 is aware when available new media contract versions may be more recent than versions of the initial contracts that have been set up with content providers. As a result, the media management system 150 can also monitor availability of new media contract versions and manage contract replacement.

In the case of contract renewal, the contract manager 156 can interact with a notification manager 158 and an expiration manager 160. The notification manager 158 determines whether notifications are to be sent to content providers, such as a notification of an expiring media contract or notification of a renewed contract. The expiration manager 160 operates to determine when a media contract has expired and then take appropriate action, such as preventing further distribution of media content that was previously authorized by the now expired media contract.

In the case of availability of new media contract versions, the contract manager 156 can interact with notification manager 158 and version manager 161. The notification manager 158 may determine whether notifications are to be sent to content providers, such as a notification of availability of the new media contract version to replace the initial contact. Such a notification can inform a content provider to replace the initial contract with the new media contract version within a predetermined time period, so as to provide for continued submission of new media content by the content provider to the media distribution system 154.

The version manager 161 may operate to determine availability of the new media contract versions to replace the initial contracts. The contract management system 152 may determine whether the initial contracts have been replaced with the new media contract versions within the predetermined period of time, and then may take appropriate action, such as preventing the continued submission of new media content when the initial contract has not been replaced with the new media contract version within the predetermined period of time.

The contract management system 152 is coupled to the media distribution system 154. Typically, the media distribution system 154 interacts with contract management system 152 to determine whether a content provider has an appropriate contract with the media distribution system 154. The media distribution system 154 also interacts with the media content database 164. The media content database 164 stores media content that is available for distribution by the media distribution system 154. In one embodiment, the media distribution system 154 supports an online media store from which numerous users can purchase media content over a data network (such as the Internet).

FIG. 1C is a schematic diagram of a contract database organization 180 according to one embodiment. The contract database organization can be used with the contract database 116 illustrated in FIG. 1A or the media content database 164 illustrated in FIG. 1B. The contract database organization 180 includes a content provider table 182, a contract table 184, a label table 186, a contract request table 188 and a contract template 190. The content provider table 182 stores information concerning the content provider. The content provider table 182 can include fields that can store information descriptive of the content provider or fields containing information on media content of the content provider, or authorizations for features used by the content provider. The contract table 184 contains information that describes the characteristics or features of a media contract. The contract table 184 can link to other tables that store one or more characteristics of media contracts. As shown in FIG. 1C, the contract table 184 can link to a contract type table 192, a contract country table 194 and a contract state table 196. The contract type table 192 can indicate the one or more types of media that are covered by the contract. The contract country table 194 can indicate the one or more countries (territories or regions) that are covered by the contract. The contract state table 196 can indicate a state of the contract. Exemplary states can include states: corresponding to whether the contract is “in effect” or “is not in effect” based on expiration; states of sent or received; and states corresponding to whether or not the contract “is active” or “is not active”. Typically, a given content provider will be associated with a plurality of different contracts. Hence, the contract table 184 can be replicated for each different contract with the content provider. The label table 186 contains information pertaining to a media label. Information associated with the media label can be descriptive of the media label or can pertain to management of media contracts with the media label. The contract request table 108 includes information regarding contracts that have been requested, including attributes of the contracts that have been requested. The contract template table 190 includes information concerning contract templates that have been utilized by the system when requesting contracts.

According to one aspect, a contract management system processes and manages creation of media contracts. The interested parties can vary depending upon application. One application of the contract management system is for media submission to a media distribution system operated by a digital content distributor. Such a system can be used by content providers (e.g., music labels) to submit media content to a digital content distributor which may operate a media distribution system (e.g., an online media store). Typically, the digital content distributor requires contracts with each of the music labels. The contracts authorize the digital content distributor to sell or otherwise distribute (via the media distribution system) media content that is controlled by the content providers.

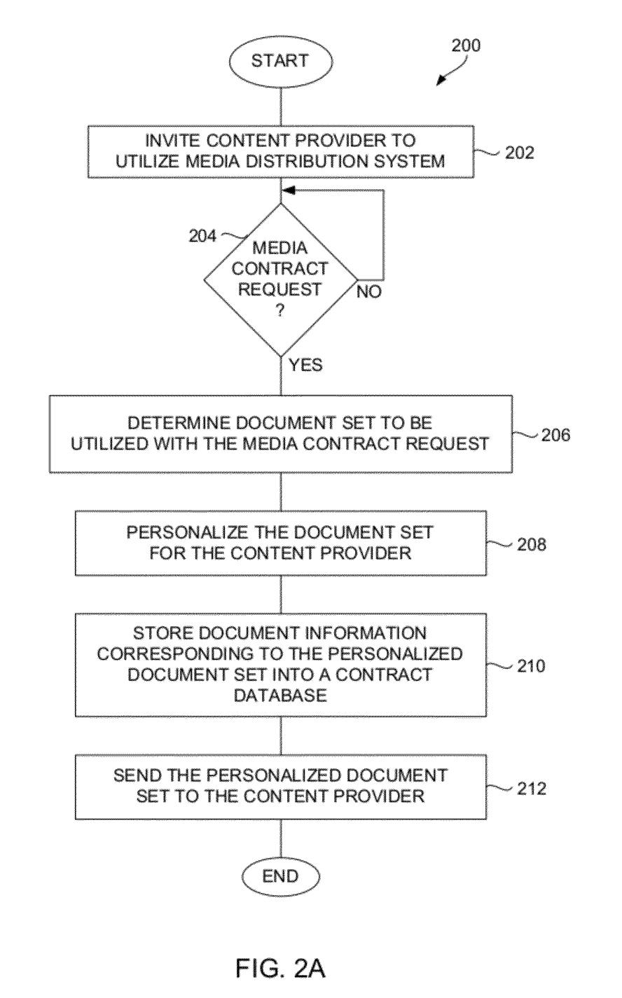

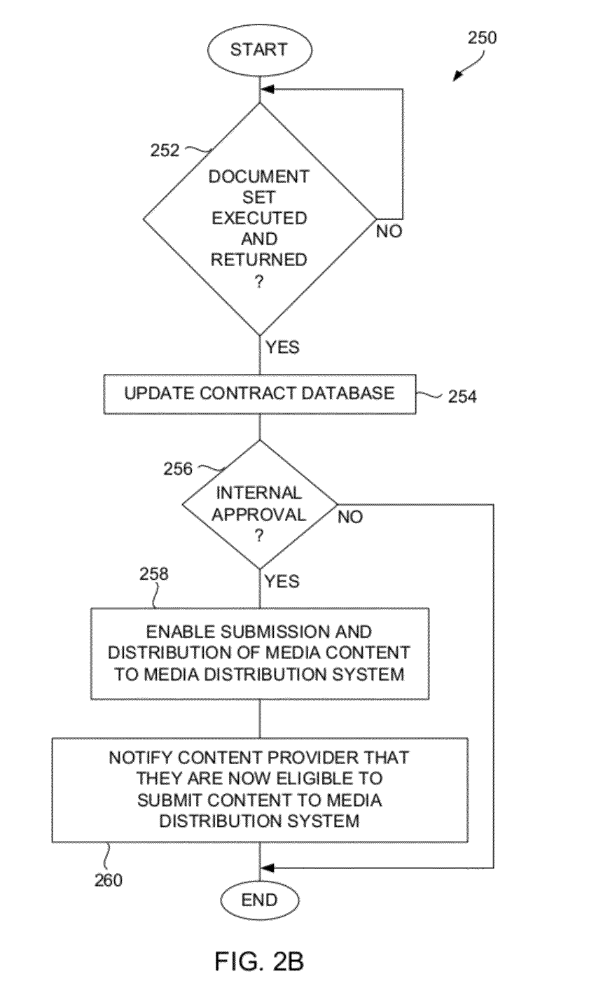

FIG. 2A is a flow diagram of a contract delivery process 200 according to one embodiment. The contract delivery process 200 concerns formation of a contract (media contract) between a content provider and a media distribution system. The contract governs distribution of media (media content) by the media distribution system. The contract delivery process 200 is, for example, performed by a contract management system, such as the contract management system 114 illustrated in FIG. 1A.

The contract delivery process 200 initially invites 202 a content provider to utilize a media distribution system to distribute media content. The media distribution system is, for example, the media distribution system 102 illustrated in FIG. 1A. Typically, the media distribution system supports an online media store from which media content provided by the content provider can be made available for purchase. Hence, the content provider is being invited 202 to provide media content to the media distribution system. In this embodiment, the content providers are being invited to participate and those that are invited can request a media contract with the media distribution system.

After the content provider has been invited 202, a decision 204 determines whether a media contract request has been received. Here, the content provider can initiate a media contract request with the media distribution system. A media contract can also be referred to as a media distribution agreement. In one embodiment, the media content request specifies the type of contract being requested and identifies the content provider. The media distribution system may require that the contract request include additional information about the content provider. The media distribution system may also already have access to additional information pertaining to the content provider (e.g., account information, etc.). When the decision 204 determines that a media contract has not yet been requested, the contract delivery process 200 awaits such a request.

Once the decision 204 determines that a media contract has been requested, a document set to be utilized with the media contract request is determined 206. In one implementation, the document set pertains to a plurality of documents that are associated with a media contract. For example, the document set can include a media contract, tax related forms, and bank forms. In one embodiment, the document set being determined 206 is dependent on a particular type of media contract being requested. Next, the document set is personalized 208 for the content provider. In this regard, the documents within the document set can be completed for use by the content provider. For example, the name, physical address, email address, etc. of the content provider can be inserted into the appropriate regions of one or more documents in the document set. While the personalization of the document set at this point may only partially complete the various open fields of the documents that need to be completed, other information can be later provided by the content provider. The media contract can also indicate and/or be associated with a unique contract number that has been assigned to the contract. In addition, the contract number can be linked to the content provider.

Next, document information corresponding to the personalized document set is stored 210 into a contract database. The contract database thus maintains a record of the status and characteristics of the media contract. In this case, although the media contract is not yet in effect, the status and characteristics of the media contract are stored in the contract database. The personalized document set is then sent 212 to the content provider. Typically, the personalized document set is transmitted electronically to the content provider. For example, the personalized document set can be sent as an attachment to an electronic mail message that is sent to the content provider. After the personalized document set has been sent 212 to the content provider, the contract delivery process 200 ends.

After the content provider receives the personalized document set, the content provider reads and completes the various documents in the document set. Although the documents in the document set have been personalized at least to a limited extent for the content provider, the documents typically require further completion by the content provider. The content provider can complete the documents through hand-written modifications to printed versions of the documents or through electronic completion of the documents as electronic documents. Alternatively, the system could require that the media contract request provide further information concerning the content provider at an early stage of the process so that the documents in the document set can be further personalized in an automated fashion before being sent to the content provider, thereby reducing or eliminating the need for the content provider to modify the documents being provided.

In an alternative embodiment, the content provider can be provided with the document set by directing the content provider to a particular network address where the document set can be accessed. The content provider can then complete the documents of the document set online (e.g., online forms). Then, to the extent that the documents need to be signed by the content provider, the documents can be printed and then physically signed or the documents can be electronically signed.

Although the embodiment illustrated in FIG. 2A is initiated by way of an invitation, in other embodiments, content providers can be permitted to request contracts without being invited. For example, when a content provider accesses the contract management system, the system can present the content provider with information on available contract opportunities. The available contract opportunities can include contract upgrades or extensions. For example, a contract extension can add contractual coverage for additional territories or countries, and a contract upgrade can add contractual coverage for an additional media type.

FIG. 2B is a flow diagram of a contract completion process 250 according to one embodiment. The contract completion process 250 follows from the contract delivery process 200 illustrated in FIG. 2A. The contract completion process 250 is, for example, performed by a contract management system, such as the contract management system 114 illustrated in FIG. 1A.

The contract completion process 250 begins with a decision 252. The decision 252 determines whether the document set (previously provided to a content provider) has been executed and returned. When the decision 252 determines that the document set has not yet been executed and returned, the contract completion process 250 awaits the return of the document set. On the other hand, once the decision 252 determines that the document set has been executed and returned, the contract completion process 250 proceeds. In other words, the contract completion process 250 can be deemed to be invoked once a document set has been executed and returned to the contract management system.

Once the contract completion process 250 has received a document set that has been executed and returned, the contract database is updated 254. For example, the contract database can be updated 254 to include a status update for the document set. As an example, the status of the contract or document set can be indicated as being “returned”. The contract database may also include text and/or images of the documents of the document set. Upon review of the document set, additional information pertaining to the document set can be stored in the contract database.

Next, a decision 256 determines whether internal approval of the media contract has been provided. The internal approval is, for example, provided by a representative of the media distribution system. The internal approval can determine whether the media contract is to be accepted. When the decision 256 determines that internal approval has been provided, the submission and distribution of media content to the media distribution system is enabled 258. This enablement of submission and distribution of media content can be performed by denoting such in the contract database. The media distribution system can then access the contract database to determine whether media content being offered for distribution is covered by a media contract that is effective and characterized in the contract database. Following the block 258, the content provider is notified 260 that they are now eligible to submit content to the media distribution system. For example, an electronic notification (such an electronic mail message) can be sent to the content provider.

On the other hand, when the decision 256 determines that internal approval has not yet been provided, the blocks 258 and 260 are not performed (i.e., bypassed). In this case, submission and distribution of media content provided by the content provider is not yet enabled. However, subsequently, the internal approval could be provided so that the content provider would be eligible to submit content to the media distribution system. Following the block 260, or following the decision 256 when internal approval is not provided, the contract completion process 250 ends.

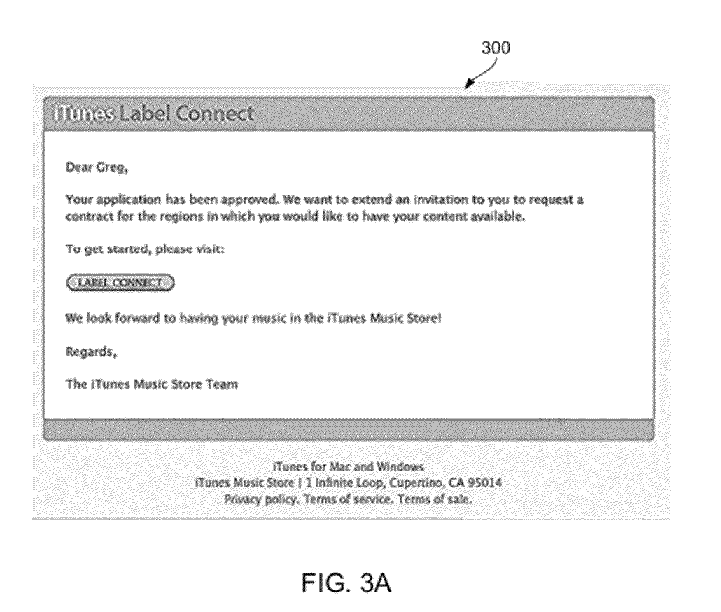

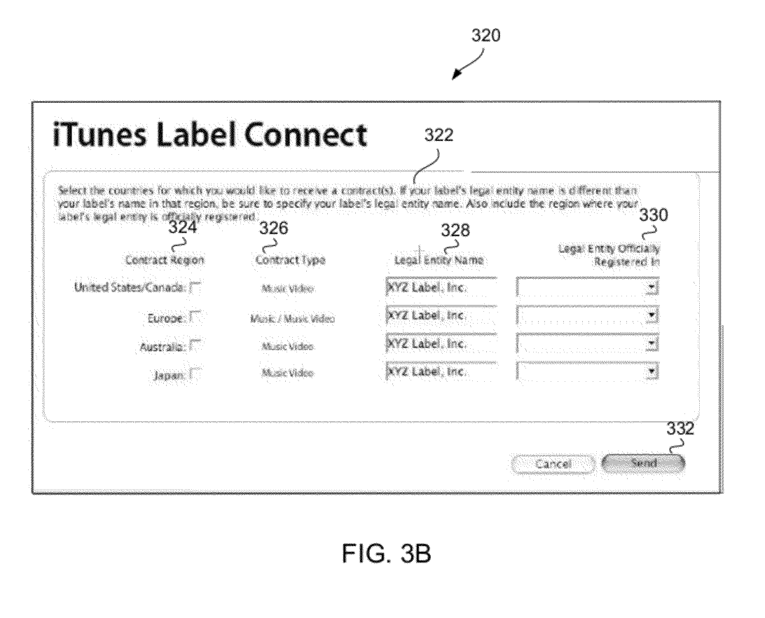

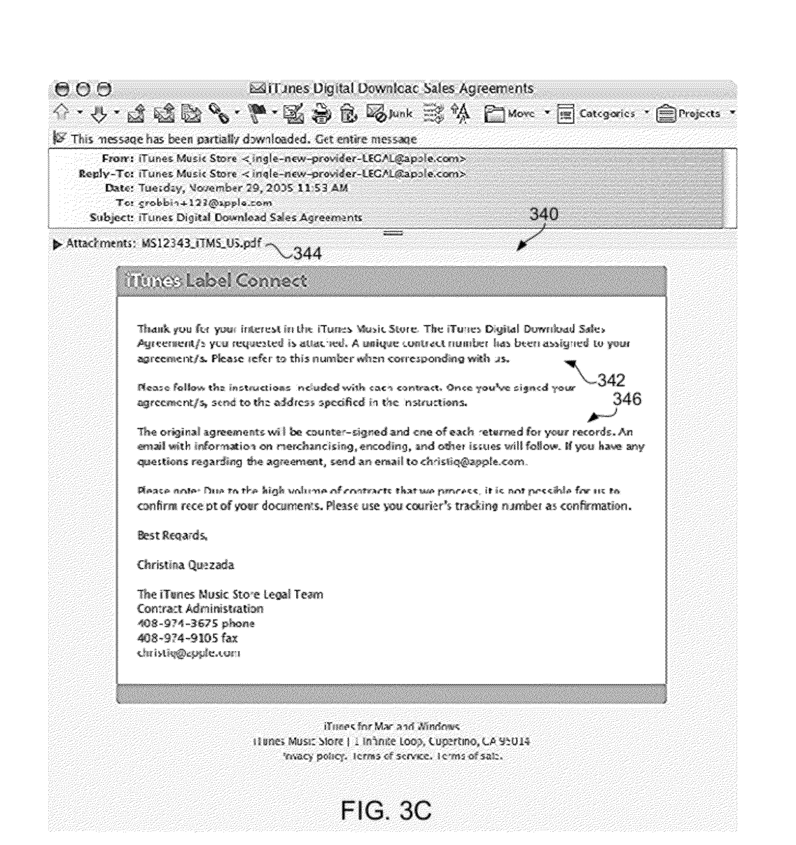

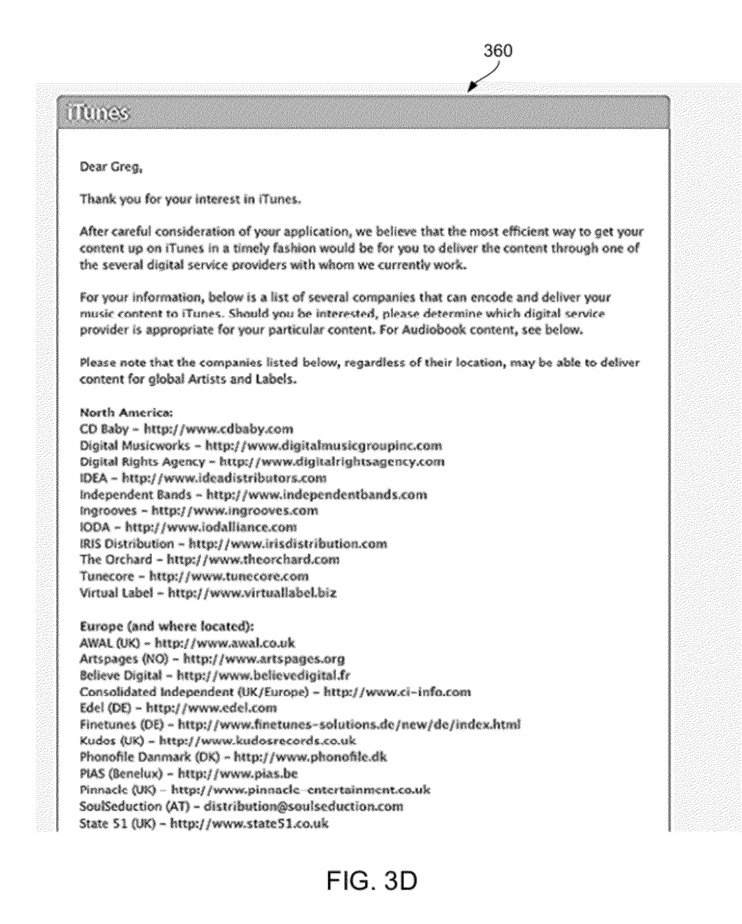

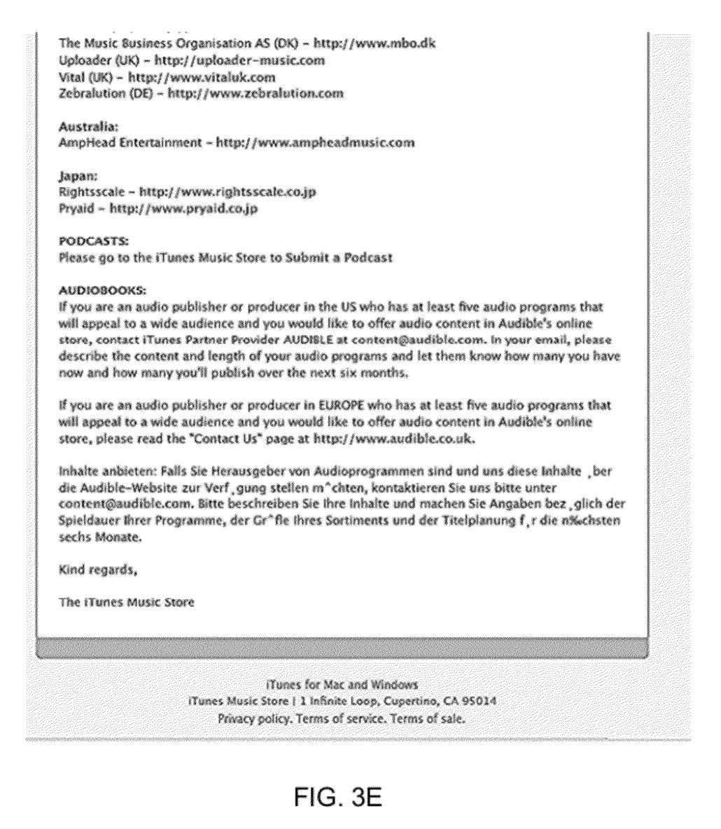

FIG. 3A illustrates an exemplary e-mail message 300 that can be sent to a content provider (i.e., user) to invite the content provider to apply for usage of the media distribution system. Here, in applying for usage, the content provider requests a contract for a particular region that the content provider desires to have media content distributed by the media distribution system. If the content provider accepts the invitation to apply, then the user accesses a contract management system. In this example, the contract management system is denoted “Label Connect.” Label Connect can not only provide contract management but also provide other tools to assist content providers with submitting digital content to a media distribution system (such as a digital content distributor). In this example, the digital content distributor is Apple Inc., who distributes media via their online media store. One available tool (e.g., iTunesProducer) available from Label Connect assists a content provider with submitting media content.

FIG. 3B illustrates an exemplary contract request screen 320 according to one embodiment. When a content provider accesses the contract management system to request a contract for distribution of media content, the exemplary contract request screen 320 can be presented to the content provider. The content provider can access the contract management system using a network browser or an application program supporting network access. In general, using the contract request screen 320, the content provider can indicate in which territories or regions they would like a contract. The contract request can also be for different types of content, such as music, videos, video and music, etc. Different content types can be available in different territories or regions. The type of content that is available can be dependent on the region or territory, existing contracts the content provider already has, and/or content types being offered by the contract management system. In particular, the contract request screen illustrated in FIG. 3B includes contract request instructions 322 and a listing of available contracts that can be requested. The list of available contracts can be dependent on one or more of: the content provider, the media distribution system, and existing contracts. In this example, the listing of available contracts includes a contract region 324, a contract type 326, a legal entity name 328, and a legal entity officially registered in area 330. More specifically, as shown in FIG. 3B, the content provider can request any of four available contracts. The contract region 324 for the four available contracts are “United States/Canada”, “Europe”, “Australia” and “Japan”. The contract type 326 for the four existing contracts is either “Music Video” which covers music and video or “Music/Music Video” which covers both music and music videos. To start the contract request, the content provider selects one or more of the four available contracts and then selects a “Send” button 332 to request the one or more selected contracts.

FIG. 3C illustrates a representative e-mail message 340 that can be sent to a contract provider when they are approved for a new contract (e.g., sales agreement). Here, the e-mail message 340 includes contract information 342 that informs the content provider that they have been approved. In addition, the e-mail message 340 can enclose a document set 344 that has been created for the content provider. In this example, the contract is a PDF file. The document set 344 can include not only the contract for the one or more territories and one or more content types but also any other supporting documents that may be required (e.g., banking information, taxpayer identification number forms, etc.). The e-mail message 340 further includes contract completion instructions 346 that inform the content provider on how to properly complete and return some or all of the document set.

FIGS. 3D and 3E illustrate a representative e-mail message 360 sent to a content provider (applicant). In this case, the content provider was not accepted for direct submission of media content to the media distribution system (e.g., digital content distributor). Instead, the content provider is encouraged to use an authorized third-party to deliver their media content to the media distribution system.

According to another aspect, a contract management system processes and manages renewal of media contracts. According to one embodiment of the invention, the renewal process for content providers can be provided by a contract management system. The contract management system can start reminding current contract holders a predetermined number of days (e.g., 100 days) prior to expiration of their existing contracts. The initial reminders alert the contract providers that they need to update their contract. When the content providers want to update their contract, they can interact with the online contract management system (e.g., Label Connect) to request contract renewals. Here, a content provider can request a contract for a particular region, and then as noted above, the contract (if approved by business or legal representatives) can cause the contract management system to produce a contract that can be provided to the user. Subsequently, when the contract is executed and returned, the contract management system can update a database to indicate that the content provider is now under a renewed contract.

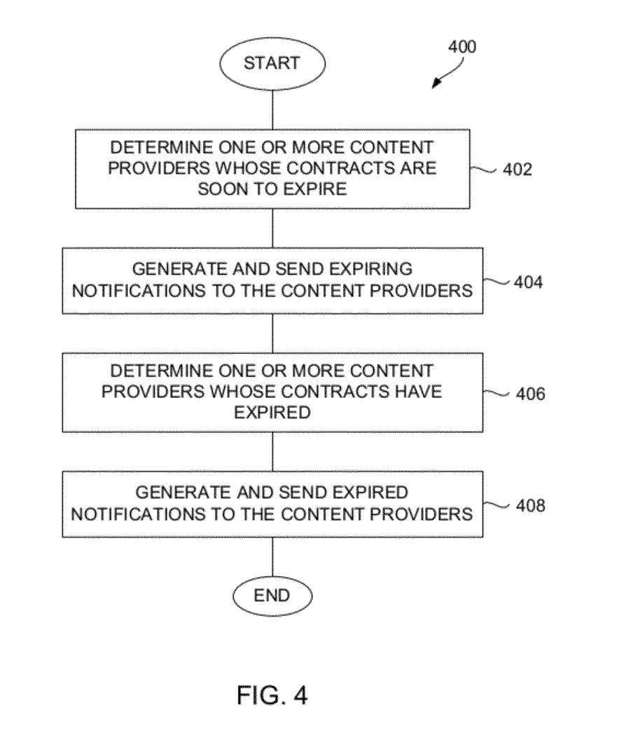

FIG. 4 is a flow diagram of a contract renewal notification process 400 according to one embodiment of the invention. The contract renewal notification process 400 operates to notify content providers that their contracts (media contracts) are approaching their expiration date. As a result, content providers are encouraged to take action to renew their contracts so that media content associated with such content providers can continue to be authorized for submission and distribution by appropriate contracts.

The contract renewal notification process 400 determines 402 one or more content providers whose contracts are soon to expire. As an example, the contract renewal notification process 400 can access a contract database to determine the one or more content providers whose contracts are soon to expire. Next, expiration notifications are generated and sent 404 to the content providers. The expiration notifications inform the content providers that their contracts are soon to expire and they should take appropriate action to renew such contracts. As an example, the expiration notifications can be electronic mail messages that are sent to the content providers.

In addition, the contract renewal notification process 400 can also inform content providers that their contracts have expired. Hence, the contract renewal notification process 400 also determines 406 one or more content providers whose contracts have expired. For such content providers, expired notifications are generated and sent 408 to the content providers. As an example, the expired notifications can be electronic mail messages that are sent to the content providers. Following the block 408, the contract renewal notification process 400 ends.

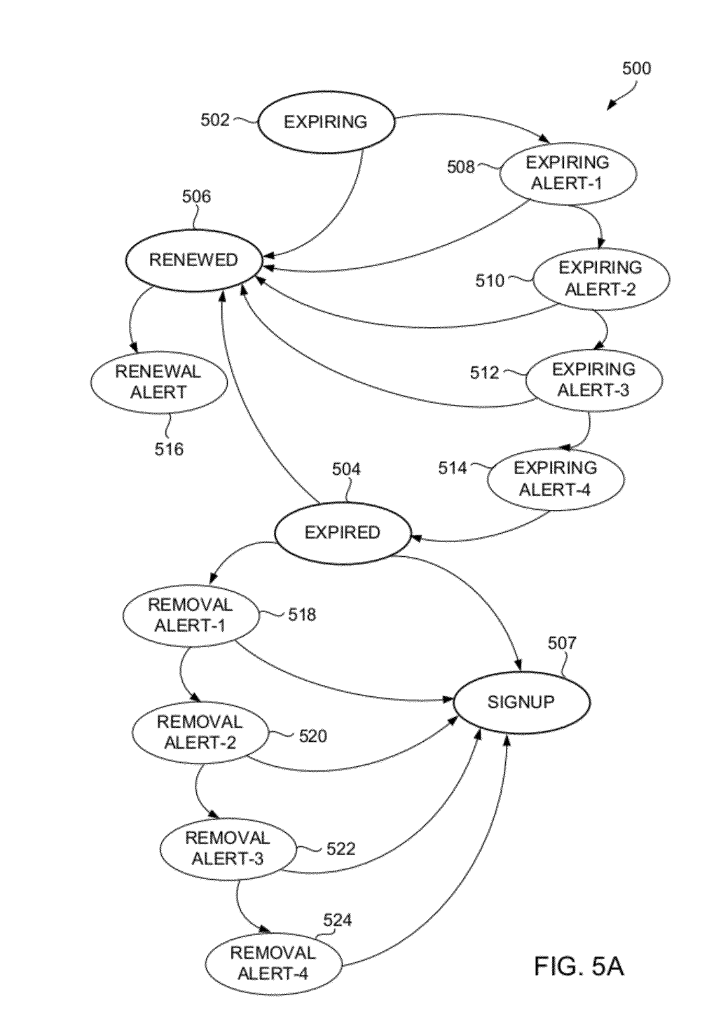

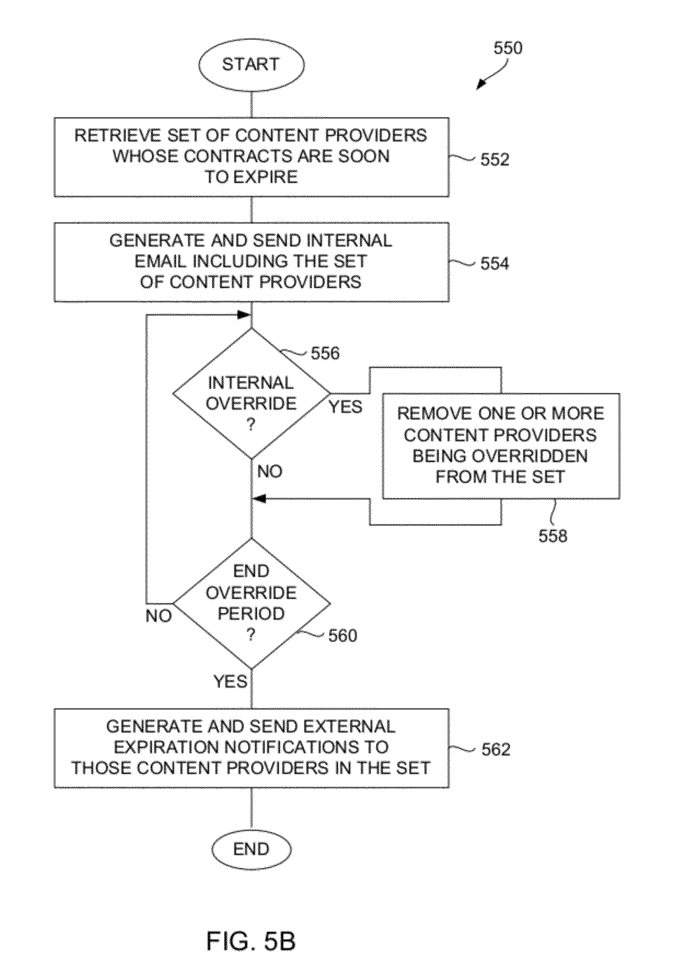

FIG. 5A is a diagram of a retrieval notification system 500 according to one embodiment of the invention. The retrieval notification system 500 illustrates a series of contract states as well as a series of different notifications that can be produced and provided to content providers. In particular, the renewal notification system 500 indicates four states for a contract once a contract has been formed. These states include a expiring state 502, an expired state 504, a renewed state 506, and a signup state 507. A contract can be placed in the expiring state 502 when the contract is not yet expired but is approaching its expiration date. In this case, the content provider associated with the expiring contract is alerted (or notified) through a series of electronic mail messages. Specifically, a first expiring alert 508 can be provided to the content provider 90 days prior to expiration of the contract. Next, a second expiring alert 510 can be provided to the content provider 30 days prior to expiration. Still further, a third expiring alert 512 can be provided to the content provider 10 days prior to expiration. Still further, a fourth expiring alert 514 can be provided to the content provider 1 day prior to expiration. Each of the expiring alerts 508-514 can inform the content provider that their contract will expire shortly and that the contract should be renewed in order to avoid expiration of the contract. The content provider can, in response to an expiring alert or otherwise, interact with the system to renew the contract.

In the event that the content provider does not take any action to renew the contract, the contract enters the expired state 504. When the contract is in the expired state 504, the contract no longer authorizes the submission and/or distribution of media content associated with the content provider. Hence, a media distribution system using the contract will typically cease selling the media content associated with the content provider already provided to the media distribution system. In addition, the media distribution may also prevent submission of media content from the content provider having the expired contract. In one embodiment, when the contract for a content provider has expired, the media distribution system automatically (i) ceases selling the media content that is no longer covered by an active contract, and (ii) prevents submission of media content to the media distribution system. A given content provider can have multiple contracts with the media distribution system such that some content of the content provider can continue to be sold even though other content is prevent from being sold.

To continue to have the media distribution system distribute media content associated with the content provider, the content provider must take action to renew their one or more contracts with the media distribution system. Hence, the contract state can either transition from the expiring state 502 to the expired state 504 or to a renewed state 506. The contract that is renewed can be considered in the renewed state. In the event that the contract is renewed, the contract enters the renewed state 506. Once the contract is renewed, a renewal alert 516 can be sent to the content provider. The renewal alert 516 can inform the content provider that their contract has been renewed and that their content can continue to be distributed by the media distribution system. However, even though the contract has been renewed, in the future the renewed contract will become an expiring contract when it is soon to reach its expiration date.

In addition, when the contract is in the expired state 504, and the content provider has not taken action to renew the contract, a series of removal alerts can be provided to the content provider. The removal alerts operate to inform content providers of the expired nature of their contract and their loss of distribution ability with respect to the media distribution system. In particular, as shown in FIG. 5A, a first removal alert 518 can be provided to the content provider on the day that the contract expires. A second removal alert 520 can be provided to the content provider the day after the contract expires. A third removal alert 522 can be provided to the content provider the second day after the contract expires. A fourth removal alert 524 can be provided to the content provider a third day after the contract has expired. In the event that the expired contract is to be replaced by a new contract prior to the timing of the removal alerts 518-524, the contract is placed in the signup state 507 and any subsequent removal alerts would not be sent to the content provider. At the signup state 507, the content provider can proceed to sign a new contract for media distribution.

FIG. 5B is a flow diagram of a renewal notification process 550. The renewal notification process 550 is, for example, performed by a contract management system, such as the contract management system 114 illustrated in FIG. 1A.

The renewal notification process 550 initially retrieves 552 a set of content providers whose contracts are soon to expire. For example, contracts can be considered soon to inspire if they are within a predetermined number of days (e.g., 90, 60, 30 or 10 days) prior to their expiration date. After the set of content providers has been retrieved 552, an internal e-mail including the set of content providers is generated and sent 554. The e-mail can be sent to one or more representatives (i.e., persons) associated with a media distribution system that are involved with contract management. The e-mail enables the representatives that receive the e-mail to invoke an internal override. Next, a decision 556 determines whether an internal override has been issued. Here, an internal override can be issued by a representative of a media distribution system anytime during an override window. The override window is typically a number of days (e.g., 3 days). When the decision 556 determines that an internal override is present, one or more content providers are removed 558 from the set of content providers. That is, if an internal override is requested, the internal override operates to remove a specific content provider from the set of content providers.

Following block 558, as well as directly following the decision 556 when an internal override has not been issued, a decision 560 determines whether an override window has ended. The override window is a period of time after the internal e-mails are sent 554 during which an internal override can be provided. When the decision 560 determines that the override period has not ended, the renewal notification process 550 returns to repeat the decision 556 and subsequent blocks. On the other hand, once the decision 560 determines that the override has ended, external expiration notifications are generated and sent to those content providers still in the set of content providers. Following the block 562, the renewal notification process 550 ends.

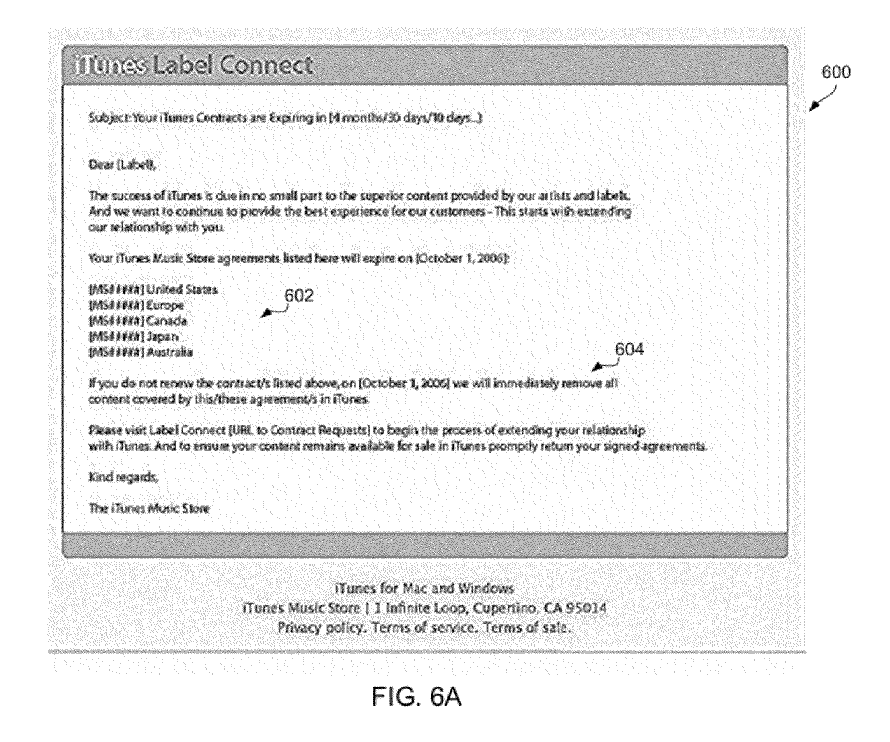

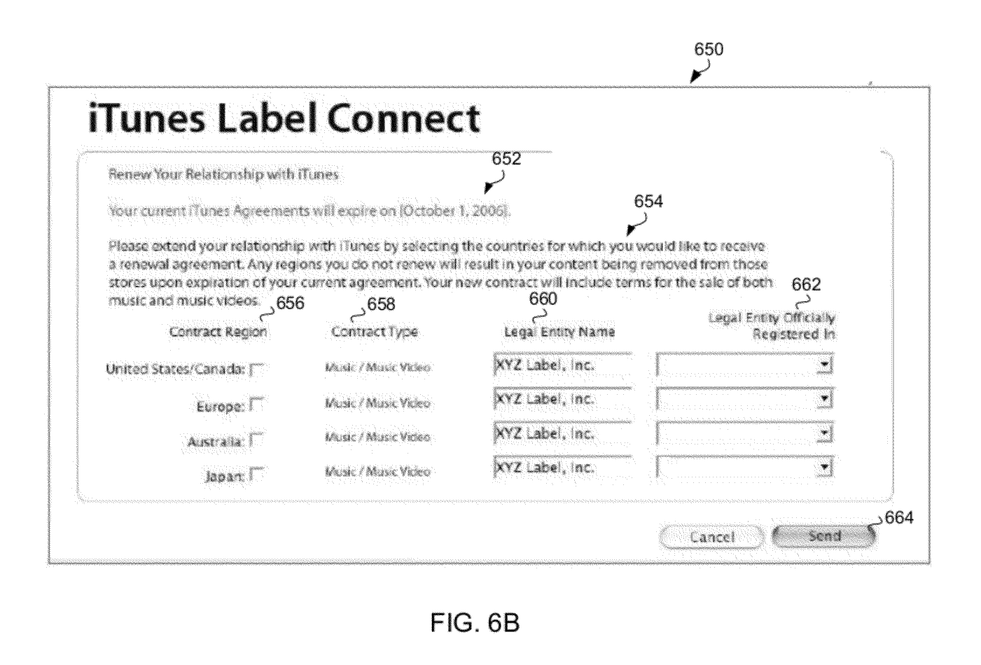

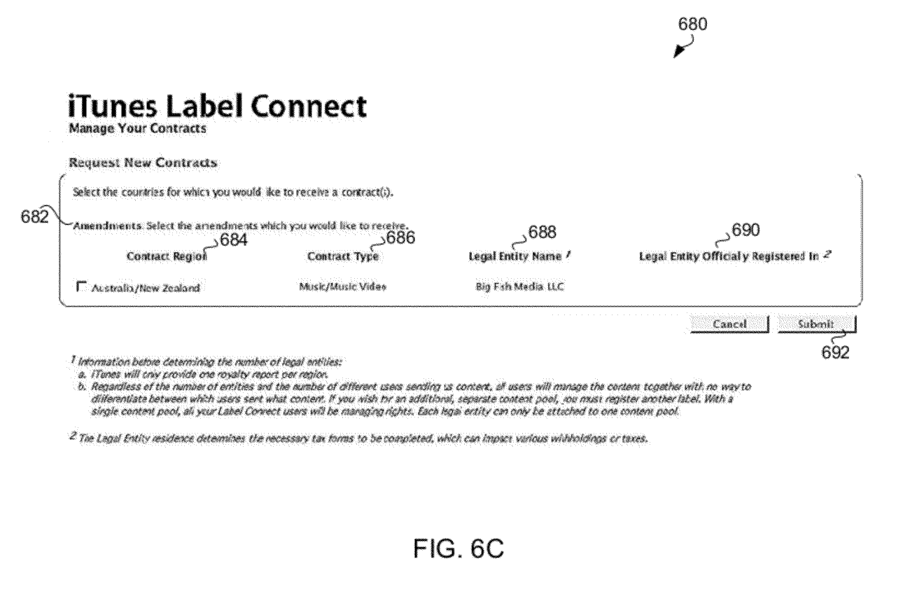

FIG. 6A is an exemplary e-mail message 600 that can be sent to a content provider (i.e., user) to inform them that one or more of their existing contracts are due to expire in several months. The e-mail message 600 informs the content provider of the particular contracts 602 that are soon to expire. The e-mail message 600 also specifically provides a warning 604 to the content provider that upon expiration of a contract, distribution of all the media content covered by the expired contract will cease. The e-mail message 600 can also provide a reference or hyperlink to the contract management system so that the content provider can easily request contract renewals.

FIG. 6B is an exemplary contract renewal screen 650 according to one embodiment of the invention. When a content provider accesses the contract management system, the exemplary contract renewal screen 650 can be presented to the content provider. The content provider can access the contract management system using a network browser or application program supporting network access. In general, using the contract renewal screen 650, the content provider can indicate those territories or regions for which they would like a renewal contract. The renewal contract(s) can also be for different types of content, such as music, videos, video and music, etc. In particular, the contract renewal screen illustrated in FIG. 6B includes an expiration warning 652, renewal instructions 654, and a listing of existing contracts that can be renewed. In this example, the listing of existing contracts includes a contract region 656, a contract type 658, a legal entity name 660, and a legal entity officially registered in area 662. More specifically, as shown in FIG. 6B, the content provider can renew any of the four existing contracts that expire on Oct. 1, 2006. The contract region 656 for the four existing contracts are “United States/Canada”, “Europe”, “Australia” and “Japan”. The contract type 658 for the four existing contracts is “Music/Music Video” which covers both music and music videos. To start the contract renewal, the content provider selects one or more of the four existing contracts and then selects a “Send” button 664 to request renewal of the one or more selected contracts.

Besides renewal of one or more existing contracts, a content provider can also upgrade from an existing contract to an expanded contract. An expanded contract can be expanded in terms of countries (e.g., territories) or in terms of content types being covered by the contract. A content provider can be offered such upgrades through notifications or when accessing the contract management system.

FIG. 6C is an exemplary contract amendment screen 680 according to one embodiment of the invention. When a content provider accesses the contract management system, the exemplary contract amendment screen 680 can be presented to the content provider. The content provider can access the contract management system using a network browser or application program supporting network access. In an amendment section 682, the contract amendment screen 680 can offer one or more contractual upgrades, namely, amendments that the content provider is eligible to obtain. Examples of amendments are contractual agreements to extend contractual coverage to additional countries (or territories) or to extend contractual coverage to additional media types. The content provider can then select any of the offered amendments that they wish to enter. For each of the available amendments, the amendment section 682 can include information on a contract region 684, a contract type 686, a legal entity name 688, and a legal entity officially registered in area 690. To start the contractual amendment, the content provider selects one or more of the available amendments and then selects a “Submit” button 692 to request the one or more selected amendments from the contract management system.

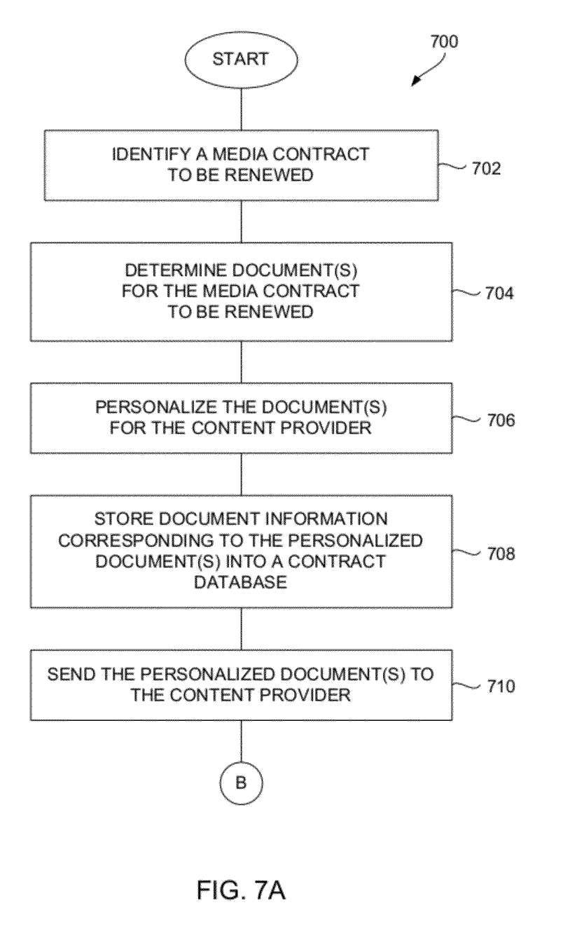

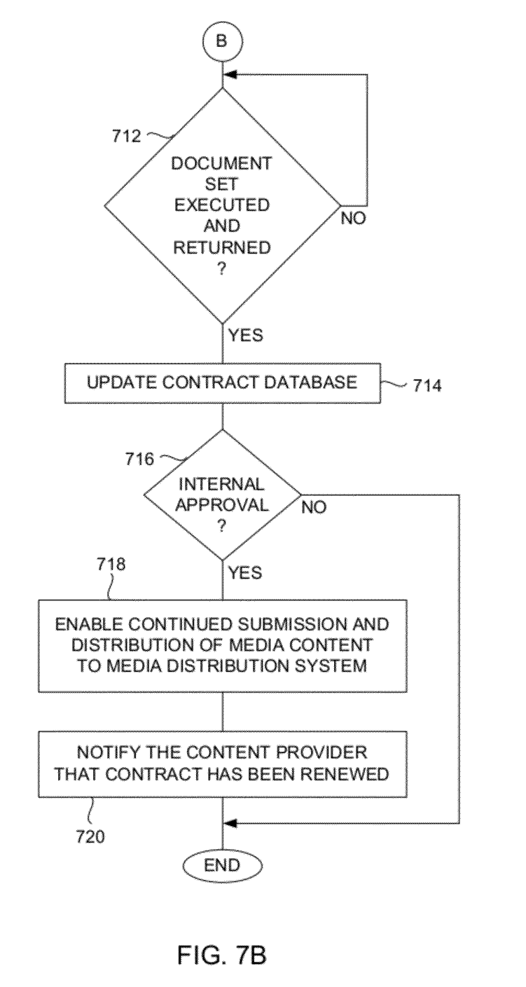

FIGS. 7A and 7B are flow diagrams of a contract renewal process 700 according to one embodiment of the invention. The contract renewal process 700 concerns renewal of a contract, namely, a media contract, with a contract management system so that a media distribution system associated therewith can continue to distribute media associated with content providers.

The contract renewal process 700 initially identifies 702 at least one contract to be renewed. Each of the contracts being identified 702 is associated with a content provider. Each content provider can have one or more contracts that need to be renewed. After a media contract has been identified 702, one or more documents for renewal of the media contract to be renewed are determined 704. The one or more documents includes at least a renewal contract. In one implementation, the one or more documents form a document set. The one or more documents for the content provider can then be personalized 706. Here, since the contract management system already knows certain information pertaining to the content provider that is required for the one or more documents, the one or more documents can be automatically modified to include such information. Next, document information corresponding to the one or more personalized documents can be stored 708 into a contract database. Hence, the characteristics of the documents within the document set can be stored to the contract database. Next, the one or more personalized documents are sent 710 to the content provider.

A decision 712 then determines whether the documents have been executed and returned by the content provider. When the decision 712 determines that the document set has been executed and returned, the contract renewal process 700 continues. When the contract renewal process 700 continues, the contract database is updated 714. The contract database can be updated 714 to include additional characteristics associated with the document set after being completed by the content provider. The contract database can also be updated 714 to alter the status of the renewal contract. For example, once the document corresponding to the renewal contract has been executed and returned, the status of the renewal contract can be “received” or “returned.”

Next, a decision 716 determines whether internal approval has accepted the renewal contract. In this embodiment, internal approval of a renewal contract is required in order for the renewal contract to be accepted by the media distribution system. When the decision 716 determines that internal approval has been provided, the renewal contract is accepted. In such case, continued submission and distribution of media content by the content provider to the media distribution system is enabled 718. In other words, the prior contract is now replaced by the renewed contract and the distribution of media content continues under the renewed contract. If the prior contract has not yet expired, then the renewal contract can take effect upon expiration of the prior contract. Alternatively, if the prior contract has not yet expired, then the renewal contract can take effect immediately upon completion of the renewal contract. In any case, if the prior contract is renewed before actual expiration, then media content from the content provider can remain available (i.e., continuously) from the media distribution system. If the prior contract expired, the submission and distribution of media content can be re-enabled for the content provider. In any case, the content provider can then be notified 720 that their contract has been renewed. On the other hand, when the decision 716 determines that the internal approval is denied, the blocks 718 and 720 are bypassed such that submission and distribution of media content is not re-enabled. Following the block 720, or its being bypassed, the contract renewal process 700 ends.

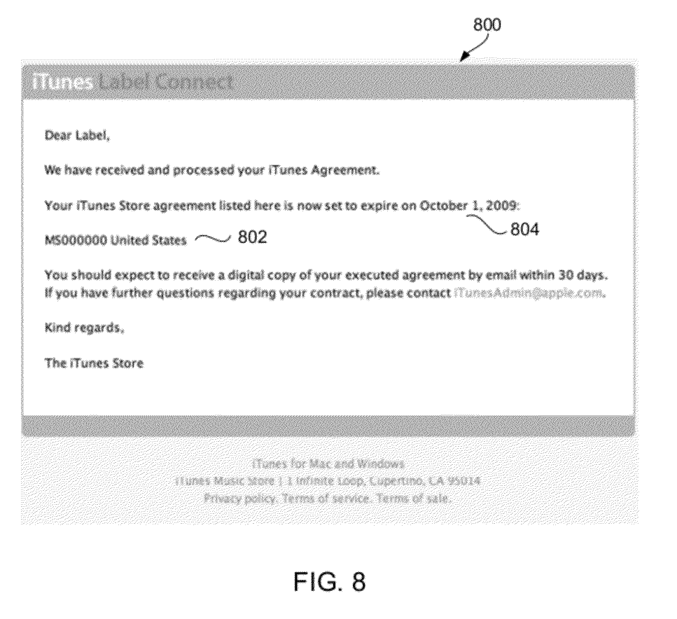

FIG. 8 is an exemplary e-mail message 800 that can be sent to a content provider (i.e., user) to inform them that one or more of their existing contracts has been successfully renewed. The e-mail message 800 informs the content provider of the particular contract 802 that has been renewed. The e-mail message 800 also informs the content provider of the expiration date 804 of the newly renewed contract.

According to another aspect, a contract management system processes and manages replacement of media contracts. According to one embodiment of the invention, the contract replacement process for content providers can be provided by a contract management system. The contract management system can replace one or more existing media contracts with one or more replacement contracts. In one example, two or more existing media contracts can be replaced by a single replacement contract having a similar or expanded scope of coverage as compared to the two or more existing contracts The contract management system can offer or encourage the replacement contract at any time in the contract cycle, that is, on expiration or before.

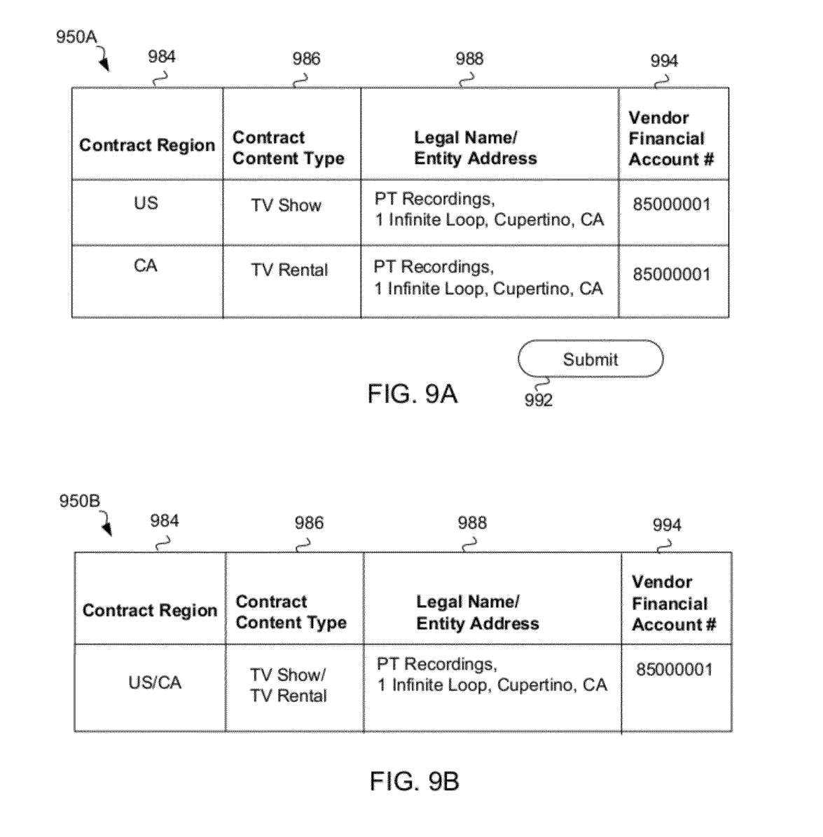

FIG. 9A is a simplified example of a media contract replacement request screen 950A. When the content provider accesses the contract management system, a media contract replacement request screen 950A, can be presented to the content provider.

In one embodiment, the media content replacement request may specify one or more prior existing media contracts to be replaced and may also identify the associated content provider. In particular, for each of two prior existing media contracts shown in FIG. 9A, the media contract replacement request screen 950A can show columns of information for contract regions 984, contract types 986, and further can show legal entity name/entity address 988 and vendor financial account number 994 for indentifying the media content provider.

Details specifying a first prior existing media contract are shown in a first row of the media contract replacement request screen 950A. The first row of the media contract replacement request screen 950A details a first geographic scope of agreement as United States (US) and details the first type of covered media content as TV Show. Details specifying a second prior existing media contract are shown in a second row of the media contract replacement request screen 950A. The second row of the media contract replacement request screen 950A details a second geographic scope of agreement as Canada (CA) and details the second type of covered media content as TV Rental.

For information to be used in generating the media contract replacement request screen 950A, the contract management system may access information of the first and second prior existing media contracts that is stored in the contract database. Accordingly, it should be understood that when the contract database stores the first prior existing agreement, the contract database stores information pertaining to a first scope of agreement for the first prior existing agreement. The first scope of agreement may comprise a first type of covered media content, which in this example is TV Show. The first scope of agreement may comprise a first geographic scope of agreement, which in this example is United States (US).

Similarly, when the contract database stores the second prior existing agreement, the contract database stores information pertaining to a second scope of agreement for the second prior existing agreement. The second scope of agreement may comprise a second type of covered media content, which in this example is TV Rental. The second scope of agreement may comprise a second geographic scope of agreement, which in this example is Canada (CA).

To start the media contract replacement request, a content provider may select a “Submit” button 992, such as shown in FIG. 9A, to submit the media contract replacement request to the contract management system, so that the contract management system may receive the contract replacement request. The receiving of the media contract replacement request may comprise receiving the media content provider request to replace the first and second prior existing media contracts with an replacement contract (or expanded contract) having an expanded scope of agreement.

The requested new contract (i.e., replacement contract) may be a new expanded contract having an expanded scope of agreement relative to the first scope of agreement of the first media contract and/or the second scope of agreement of the second media contract. In one example, the receiving the media contract replacement request may comprise receiving the media content provider request to replace the first media contract having the first scope of agreement with a new expanded contract having the expanded scope of agreement. The expanded scope of agreement may comprise a second type of covered media content in addition to the first type of covered media content. Alternatively or additionally, the expanded scope of agreement may comprise the second geographic scope of agreement in addition to the first geographic scope of agreement. In another example, the receiving the media contract replacement request may comprise receiving the media content provider request to replace both the first media contract having the first scope of agreement and the second media contract having the second scope of agreement with the new expanded contract having the expanded scope of agreement. Here, the new expanded contract is expanded beyond the coverage of the first media contract and the second media contract. The expanded scope of the expanded agreement may comprise an additional type of covered media content, or alternatively or additionally, an additional geographic region.

FIG. 9B is a simplified example of a counterpart screen to the media contract replacement request screen shown in FIG. 9A. Once the first and second prior existing media contracts are replaced with the new expanded media contract, the contract database may be updated and accessed to generate display 950B, which details the expanded scope of the new expanded media contract. The new expanded media contract illustrated in the display of FIG. 9B shows an expanded geographic scope of agreement as United States and Canada (US/CA) and shows expanded types of covered media content as TV Show and TV Rental.

Accordingly, as shown in FIG. 9B, the requested new contract may be a new expanded contract having an expanded scope of agreement relative to the first scope of agreement of the first media contract shown in FIG. 9A. For example, the expanded scope of agreement in FIG. 9B shows the new type of covered media content (TV Rental) in addition to the existing type of covered media content (TV Show). Further, the expanded scope of agreement in FIG. 9B shows the new geographic scope of agreement (Canada) in addition to the existing geographic scope of agreement (United States).

Also, as shown in FIG. 9B, the requested new contract may be a new expanded contract having an expanded scope of agreement relative to the second scope of agreement of the second media contract shown in FIG. 9A. For example, the expanded scope of agreement in FIG. 9B shows the existing type of covered media content (TV Rental) in addition to the new type of covered media content (TV Show). Further, the expanded scope of agreement in FIG. 9B shows the new geographic scope of agreement (United States) in addition to the existing geographic scope of agreement (Canada).

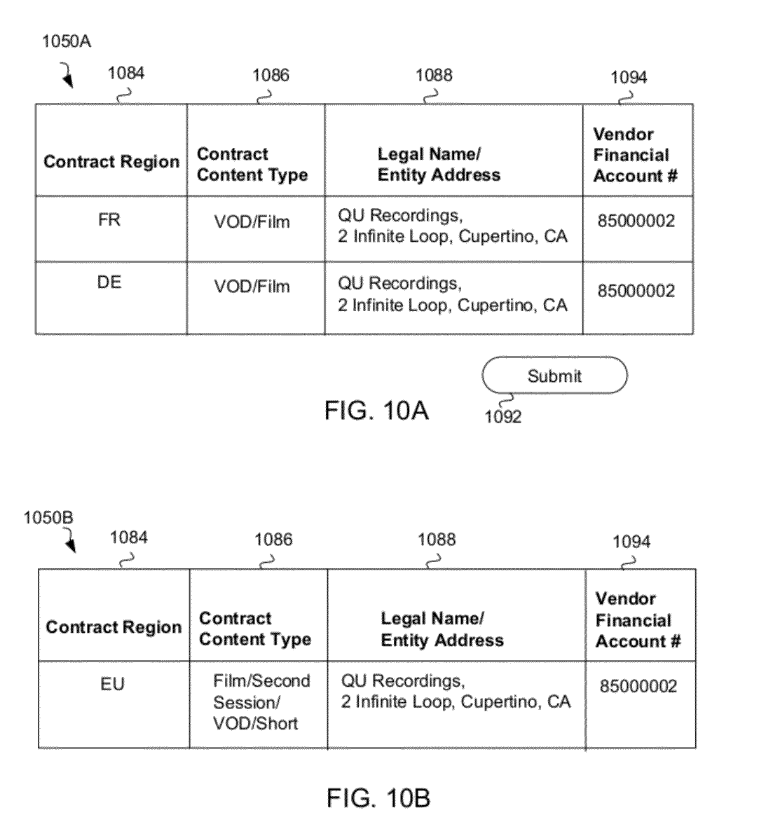

FIG. 10A is another simplified example of another media contract replacement request screen 1050A. For each of two prior existing media contracts shown in FIG. 10A, the media contract replacement request screen 1050A may show columns of information for contract regions 1084, contract types 1086, and may further show legal entity name/entity address 1088 and vendor financial account number 1094 for indentifying the media content provider.

Details specifying a first prior existing media contract are shown in a first row of the media contract replacement request screen 1050A. The first row of the media contract replacement request screen 1050A details a first geographic scope of agreement as France (FR) and details the type of covered media content as Video On Demand/Film (VOD/Film). Details specifying a second prior existing media contract are shown in a second row of the media contract replacement request screen 1050A. The second row of the media contract replacement request screen 1050A details a second geographic scope of agreement as Germany (DE) and details the type of covered media content as Video On Demand/Film (VOD/Film).

For information to be used in generating the media contract replacement request screen 1050A, the contract management system may access information of the first and second prior existing media contracts that is stored in the contract database. Accordingly, it should be understood that when the contract database stores the first prior existing agreement, the contract database stores information pertaining to a first scope of agreement for the first prior existing agreement. The first scope of agreement may comprise a type of covered media content, which in this example is Video On Demand/Film (VOD/Film). The first scope of agreement may comprise a first geographic scope of agreement, which in this example is France (FR).

Similarly, when the contract database stores the second prior existing agreement, the contract database stores information pertaining to a second scope of agreement for the second prior existing agreement. The second scope of agreement may comprise a type of covered media content, which in this example is Video On Demand/Film (VOD/Film). The second scope of agreement may comprise a second geographic scope of agreement, which in this example is Germany (DE).

To start the media contract replacement request, the content provider may select a “Submit” button 1092, such as shown in FIG. 10A, to submit the media contract replacement request to the contract management system, so that the contract management system may receive the contract replacement request. The receiving of the media contract replacement request may comprise receiving the media content provider request to replace the first and second prior existing media contracts with an expanded contract having an expanded scope of agreement.

The requested new contract (i.e., replacement contract) may be a new expanded contract having an expanded scope of agreement relative to the first scope of agreement of the first media contract and/or the second scope of agreement of the second media contract. In one example, the receiving the media contract replacement request may comprise receiving the media content provider request to replace the first contract having the first scope of agreement with the new expanded contract having the expanded scope of agreement. The expanded scope of agreement may comprise the second geographic scope of agreement in addition to the first geographic scope of agreement. Alternatively or additionally, the expanded scope of agreement may comprise the second type of covered media content in addition to the first type of covered media content. In another example, the receiving the media contract replacement request may comprise receiving the media content provider request to replace both the first media contract having the first scope of agreement and the second media contract having the second scope of agreement with the new expanded contract having the expanded scope of agreement. Here, the new expanded contract is expanded beyond the coverage of the first media contract and the second media contract. The expanded scope of the expanded agreement may comprise an additional type of covered media content, or alternatively or additionally, an additional geographic region.

FIG. 10B is a simplified example of a counterpart screen to the media contract replacement request screen shown in FIG. 10A. Once the first and second prior existing media contracts are replaced with the new expanded media contract, the contract database may be updated and accessed to generate display 1050B, which details the expanded scope of the new expanded media contract. The new expanded media contract illustrated in the display of FIG. 10B shows an expanded geographic scope of agreement as the European Union (EU).

Accordingly, as shown in FIG. 10B, the requested new contract may be a new expanded contract having an expanded scope of agreement relative to the first scope of agreement of the first media contract shown in FIG. 10A. For example, the expanded scope of agreement in FIG. 10B shows the expanded geographic scope of the European Union, which encompasses the existing geographic scope of agreement (Germany) of the second media contract in addition to the existing geographic scope of agreement (France) of the first media contract. Also, as shown in FIG. 10B, the expanded scope of agreement is also expanded as to covered media content. For example, the expanded scope of agreement in FIG. 10B shows the existing types of covered media content (VOD/Film) in addition to the new types of covered media content (Second Session and Short).

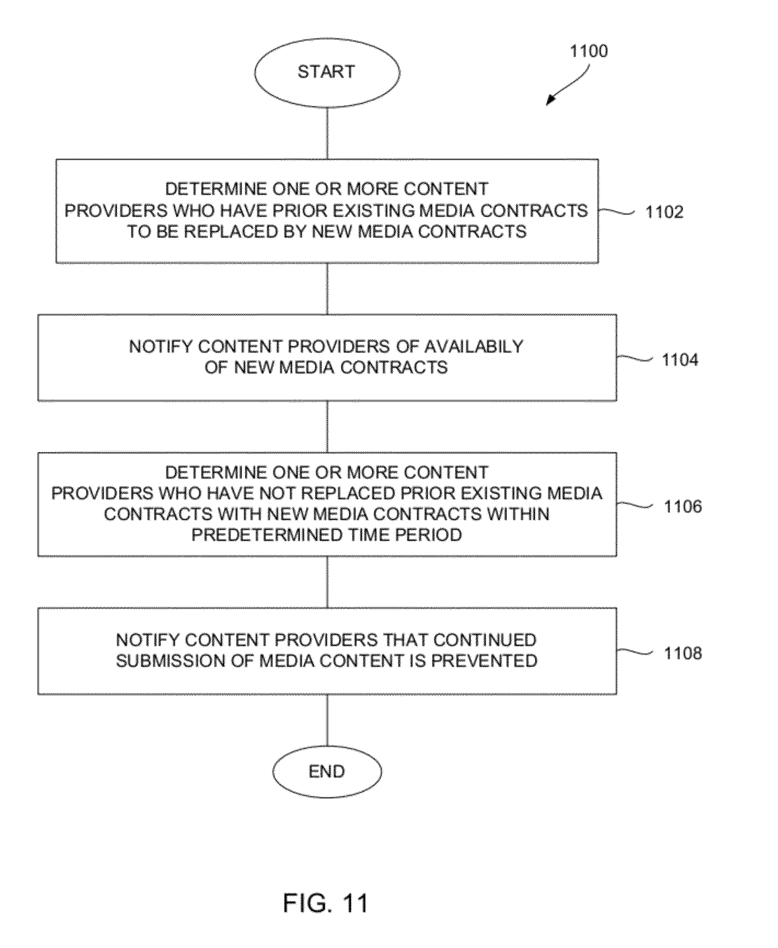

FIG. 11 is a flow diagram of a contract replacement notification process according to one embodiment. The contract replacement notification process 1100 may operate to notify content providers to replace one or more prior existing media contracts with one or more new media contracts. As a result, content providers may be encouraged to take action to submit media contract replacement requests, so that media content associated with such content providers can continue to be authorized for submission and distribution of media content by appropriate contracts.

For example, a notification manager may be configured to notify media content providers with prior existing media contracts to replace prior existing media distribution contracts with new media contracts. In particular, the notification manager may be configured to notify the media content providers to replace prior existing media contracts with new media contract versions. The new media contracts may be more recent than versions of the prior existing media contracts, may be replacement contracts offering expanded scope of coverage, and/or may consolidate multiple existing media contracts to a single replacement contract.

As shown in FIG. 11, the contract replacement notification process 1100 may initially determine 1102 one or more content providers who have prior existing media contracts to be replaced by the new version of the media contracts. As an example, the contract replacement notification process 1100 may access a contract database to determine the one or more content providers who have prior existing media contracts to be replaced by the new version of the media contracts. As discussed previously herein, the contract manager, the notification manager and the version manager can all access the contract database. The contract database can store descriptive information concerning the media contracts. The contract information can include start date, expiration date, content provider, media type, contract status, a version number, etc.

In one implementation, as new media contract versions may become available, the new media contract versions may be more recent than versions of the prior existing media contracts with the content providers. Since the contract database maintained by the contract management system stores information on version numbers of the various contracts, the contract management system is aware when available new media contract versions may be more recent than versions of the prior existing media contracts with the content providers. As a result, the contract management system can also monitor availability of new media contract versions and manage contract replacement. When new media contract versions are available, the contract manager can interact with notification manager and version manager. The notification manager can determine 1102 one or more content providers who have prior existing media contracts to be replaced by the new version of the media contracts.

In another implementation, as new media contracts may become available, the new media contracts may offer greater scope of coverage than the prior existing media contracts with the content providers. Since the contract database maintained by the contract management system stores information on scope of coverage (e.g., media types and geographic regions supported) of the various contracts, the contract management system is aware when available new media contracts may be available to replace the prior existing media contracts with the content providers. As a result, the contract management system can also monitor availability of new media contracts and manage contract replacement. When new media contracts are available, the contract manager can interact with notification manager. The notification manager can determine 1102 one or more content providers who have prior existing media contracts to be replaced by the new media contracts which offer enhanced scope of coverage.

In still another implementation, as new media contracts may become available, the new media contracts may offer consolidation of multiple existing media contracts to a single replacement contract. The single replacement contact typically subsumes the multiple existing media contracts by providing greater scope of coverage than the prior existing media contracts with the content providers. For example, the greater scope of coverage can pertain to additional media types supported or additional geographic regions supported. Since the contract database maintained by the contract management system stores information on scope of coverage (e.g., media types and geographic regions supported) of the various contracts, the contract management system is aware when available new media contracts may be available to consolidate and thus replace the prior existing media contracts with the content providers. As a result, the contract management system can also monitor availability of new media contracts and manage contract replacement, namely, consolidation. When new media contracts are available, the contract manager can interact with notification manager. The notification manager can determine 1102 one or more content providers who have prior existing media contracts to be replaced by a new consolidated media contract which offers enhanced scope of coverage.

Next, once the one or more content providers are determined 102, the one or more content providers who have prior existing media contracts to be replaced by new media contracts may be notified 1104 of availability of the one or more new media contracts. For example, the notification manager may be configured to notify a media content provider to replace at least one prior existing media contract with a new media contract that is more recent version than versions of the at least one prior existing media contracts. As another example, the notification manager may be configured to notify a media content provider to replace at least one prior existing media contract with a new media contract that provides for an enhanced scope of coverage than do the two or more prior existing media contracts. As still another example, the notification manager may be configured to notify a media content provider to replace two or more prior existing media contracts with a new media contract that provides for a consolidated media contract that typically offers the same (or greater) scope of coverage than that offered by the two or more prior existing media contracts.

The notification manager may be configured to notify the media content provider that continued submission of media content by the media content provider to the media distribution system may be prevented, when the at least one prior existing media contract is not replaced with the new media contract within a predetermined time period. Those content providers receiving such notifications may be motivated to submit media contract replacement requests, and to replace media contracts within the predetermined time period, so as to provide for continued submission and distribution of media content by the content provider to the media distribution system. In one embodiment the notification manager may be configured to notify the media content provider that although continued submission of media content by the media content provider to the media distribution system may be prevented, distribution of media content previously submitted under one or more prior existing media contracts may continue until their expiration, even when the at least one prior existing media contract is not replaced with the new media contract within the predetermined time period.

The notification manager may be configured to notify the content providers to replace one or more prior existing media contracts by producing one or more notification messages and sending the one or more notification messages to the content providers. Alternatively, or additionally, the notification manager may be configured to notify the media content providers when they access the contract management system to replace prior existing media contracts.

Next, the contract replacement notification process 1100 may determine 1106 one or more content providers who have not replaced prior existing media contracts with the new versions of the media contracts within the predetermined time period. For example, the contract management system may operate to determine availability of the new media contract versions to replace the initial contracts, and may determine whether the prior existing media contracts have been replaced with the new media contract versions within the predetermined time period.

Next, once they are determined, such content providers may be notified 1108 that continued submission of media content is prevented. Such notification may be by producing one or more such notification messages and sending the one or more notification messages to such media content providers. Alternatively, or additionally, the notification manager may be configured to notify such media content providers when they access the contract management system or the media distribution system. Further, the version manager may be configured to take appropriate action, such as preventing the continued submission of new media content when the prior existing media contract have not been replaced with the new media contract version within the predetermined period of time. Although continued submission of media content by the media content provider to the media distribution system may be prevented, the contract management system and the media distribution system may be configured for continuing distribution of media content previously submitted under one or more prior existing media contracts, where such distribution continues until contract expiration, even when the at least one prior existing media contract is not replaced with the new media contract within the predetermined time period. Following the block 1108, the contract replacement notification process 1100 may end.

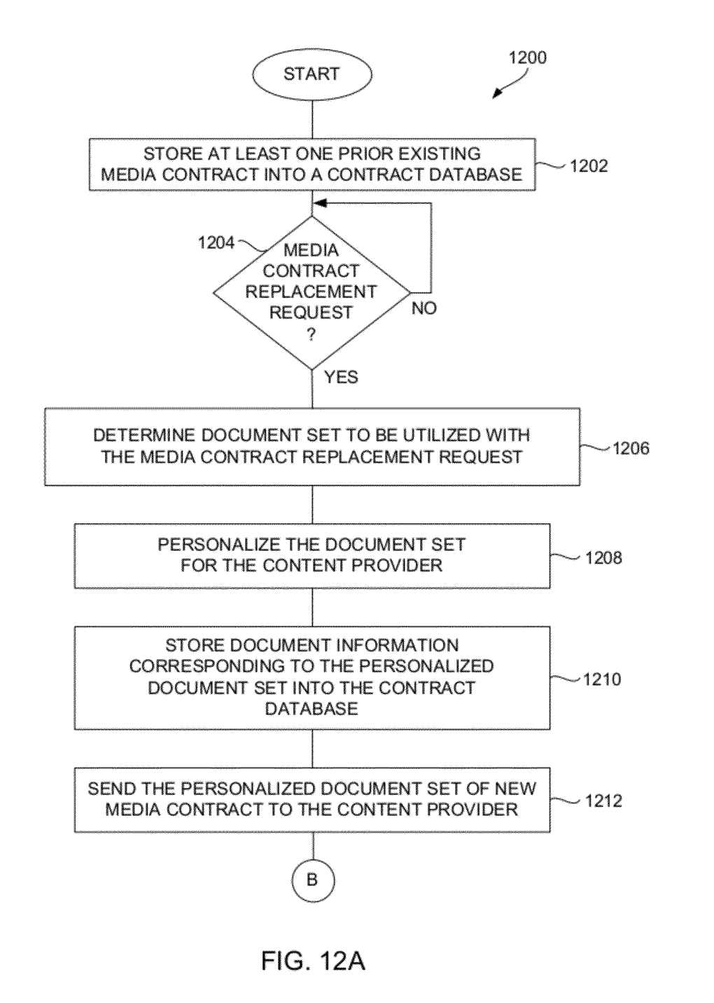

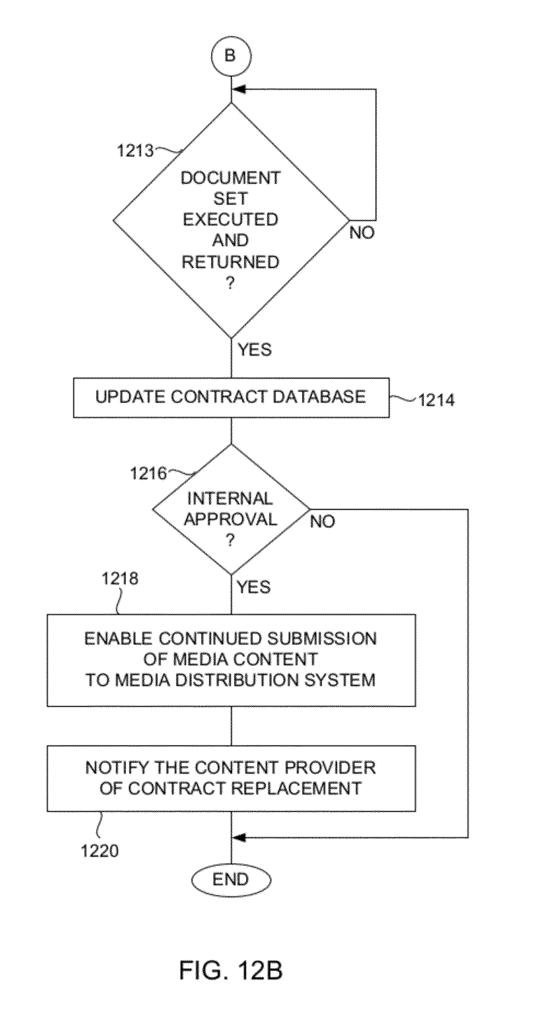

FIGS. 12A and 12B are flow diagrams of a contract replacement process 1200 according to one embodiment of the invention. The contract replacement process 1200 concerns replacement of at least one contract, namely, at least one prior existing media contract with a new media contract, using a contract management system, so as to provide for continued submission of media content by the content provider to the media distribution system as well as distribution of the media content. Whereas submission of media content may previously have been under the at least one previously existing media contract, once the at least one previously existing media contract is replaced with the new media contract, continued submission of new media content by the content provider to the media distribution system may be under the new media contract.

For the contract replacement process 1200, at least one prior existing media contract may be initially stored 1202 into a contract database. For the at least one prior existing media contracts stored in the contract database is associated with a content provider. For a given content provider, one or more prior existing media contracts may need to be replaced.

The storage 1202 of the at least one prior existing contract may comprise storing a first contract having a first scope of agreement. The first scope of agreement may comprise a first type of covered media content. The first scope of agreement may also comprise a first geographic scope of agreement.

The storage 1202 may further comprise storing a second prior existing media contract having a second scope of agreement in the database. The second scope of agreement may comprise a second type of covered media content. The second scope of agreement may also comprise a second geographic scope of agreement. Once stored in the database, the foregoing may be accessed and displayed by the contract management system as at least part of a media contract replacement request screen (as discussed previously herein with reference to the examples of FIGS. 9A and 10A.)

Next, a decision 1204 may determine whether a media contract replacement request has been received. Here, the content provider can initiate a media contract replacement request with the media distribution system. The requested new contract may be a new expanded contract having an expanded scope of agreement relative to the scope of agreement of the prior existing media contract. The receiving the media contract replacement request may comprise receiving the media content provider request to replace the one or more existing media contracts having existing scope of agreement with the new expanded contract having the expanded scope of agreement.

The media contract replacement request may comprise receiving the media content provider request to replace the first and second prior existing media contracts with the expanded contract having the expanded scope of agreement. The expanded scope of the expanded contract may comprise the second type of covered media content in addition to the first type of covered media content. The expanded scope of expanded contract may comprise the second geographic scope of agreement in addition to the first geographic scope of agreement.

The media contract replacement request may be motivated by the content provider being notified to replace one or more prior existing media contracts through notifications or when they access the contract management system (or media management system), as mentioned previously herein. For example, the notification manager may be configured to notify media content providers with prior existing media contracts to replace prior existing media distribution contracts with new media contracts having an expanded scope. In particular, the notification manager may be configured to notify the media content provider to replace prior existing media contracts with a new media contract version.

The notification manager may be configured to notify the media content provider that continued submission of media content by the media content provider to the media distribution system may be prevented, when the at least one prior existing media contract is not replaced with the new media contract within a predetermined time period. The contract management system may be configured to prevent continued submission of media content to the media distribution system by the media content provider when the at least one prior existing media contract is not replaced with the new media contract within a predetermined time period.

The notification manager may be configured to notify the content provider to replace prior existing media contracts by producing one or more notification messages and sending the one or more notification messages to the media content provider. Alternatively, or additionally, the notification manager may be configured to notify the media content provider when they access the contract management system (or media management system).

When the content provider accesses the contract management system, a media contract replacement request screen (which may be similar to the examples of FIGS. 9A and 10A) can be presented to the content provider. In one embodiment, the media content replacement request may specify one or more prior existing media contracts to be replaced and identify the content provider. To start the media contract replacement requests, the content provider may select a “Submit” button (see FIGS. 9A and 10A) to submit the media contract replacement request to the contract management system.

When the decision 1204 determines that media contract replacement has not yet been requested, the contract delivery process 1200 awaits such a request. Once the decision 1204 determines that media contract replacement has been requested, a document set to be utilized with the media contract replacement request is determined 1206. In one embodiment, the document set includes one or more documents. The one or more documents includes at least a new media contract to replace the at least one prior existing media contract.

The document set can then be personalized 1208 for the media content provider. For example, the contract management system may retrieve media content provider information associated with the media content provider from the media content provider account. The contract management system may dynamically and automatically personalize the document set for the media content provider, each of a plurality of documents in the document set being personalized using the retrieved media content provider information. Since the contract management system already knows certain information pertaining to the content provider that is required for the one or more documents, the one or more documents can be automatically modified to include such information.

Next, document information corresponding to the one or more documents within the personalized document set can be stored 1210 in the contract database. The document information may be descriptive of one or more of the documents in the personalized document set of the new media contract. Hence, the characteristics of the documents within the document set may be obtained and may be stored into the contract database.

Next, the one or more documents of the personalized document set may be sent 1212 to the content provider. Following said sending, the contract database may be updated to indicate that the personalized document set of the new media contract has been sent to the media content provider.

A decision 1213 may then determine whether the documents have been executed and returned by the content provider. When the decision 1213 determines that the document set has been executed and returned, the contract replacement process 1200 continues. When the contract replacement process 1200 continues, the contract database may be updated 1214. For example, the contract database can be updated 1214 to include additional characteristics associated with the document set of the new media contract after being completed by the content provider. The contract database can also be updated 1214 to alter the status of the new media contract (the replacement contract). For example, once the document corresponding to the new media contract or the new media contract has been executed and returned, the status of the new media contract or replacement contract can be “received” or “returned.”

Next, a decision 1216 determines whether internal approval has accepted the replacement contract. In this embodiment, internal approval for replacement of one or more prior existing media contracts with the new media contract may be required in order for the new media contract to be accepted by the media distribution system. When the decision 1216 determines that internal approval has been provided, the replacement contract may be accepted. In such case, continued submission of media content by the content provider to the media distribution system may be enabled 1218. In other words, the one or more prior existing media contracts may now be updated in the database in the “is not active” state, and such prior existing media contracts are now replaced by the new media contract, which may now be updated in the database in the “is active” state, and submission and distribution of new media content continues under the new media contract. The content provider can then be notified 1220 that their at least one prior existing media contract has been replaced. On the other hand, when the decision 1216 determines that the internal approval is denied, the blocks 1218 and 1220 are bypassed such that submission of media content is not re-enabled. Following the block 1220, or its being bypassed, the contract replacement process 1200 may end.

This application also references U.S. patent application Ser. No. 11/622,923 , filed Jan. 12, 2007, and entitled “Computerized Management Of Media Distribution Agreements”, which is hereby incorporated herein by reference

The various aspects, features, embodiments or implementations of the invention described above can be used alone or in various combinations.

Although the media assets (or media items) of emphasis in several of the above embodiments were audio items (e.g., songs, audio files or audio tracks), the media assets are not limited to audio items. For example, the media assets can alternatively pertain to videos (e.g., movies, television shows), podcasts, audiobooks, and/or images (e.g., photos).

The invention is preferably implemented by software, but can also be implemented in hardware or a combination of hardware and software. The invention can also be embodied as computer readable code on a computer readable medium. The computer readable medium is any data storage device that can store data which can thereafter be read by a computer system. Examples of the computer readable media include read-only memory, random-access memory, CD-ROMs, DVDs, magnetic tape, optical data storage devices, and carrier waves. The computer readable medium can also be distributed over network-coupled computer systems so that the computer readable code is stored and executed in a distributed fashion.

The many features and advantages of the present invention are apparent from the written description and, thus, it is intended by the appended claims to cover all such features and advantages of the invention. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A computer-implemented method for automated processing of media contracts for a media distribution system, said method comprising:
storing at least one prior existing media contract in a database;
receiving a media contract replacement request from a media content provider to replace the at least one prior existing media contract with a replacement media contract, the replacement media contract having a scope of agreement that is expanded beyond that of the at least one prior existing media contract being replaced;
determining a document set, by a contract management system operating on a server computer, to be utilized for the replacement media contract;
dynamically and automatically personalizing the document set by the contract management system for the media content provider; and
sending the personalized document set for the replacement media contract to the media content provider.

2. A computer-implemented method as recited in claim 1, wherein the scope of the agreement of the replacement media contract is expanded with respect to types of media content covered.

3. A computer-implemented method as recited in claim 1, wherein the replacement media contract supports at least one additional type of media content as compared to the one or more types of media content supported by the at least one prior existing media contract.

4. A computer-implemented method as recited in claim 1, wherein the scope of the agreement of the replacement media contract is expanded with respect to geographic regions covered.

5. A computer-implemented method as recited in claim 1, wherein the replacement media contract supports at least one additional geographical region as compared to the one or more geographic regions supported by the at least one prior existing media contract.

6. A computer-implemented method as recited in claim 1, wherein said method further comprises:
obtaining document information from the document set of the replacement media contract; and
storing the obtained document information into the database associated with the media distribution system, wherein the document information is descriptive of one or more of the documents in the personalized document set of the replacement media contract.

7. A computer-implemented method as recited in claim 6, wherein said method further comprises:
updating the database when the personalized document set of the replacement media contract is executed and returned; and
enabling, subsequent to said updating, submission of media content to the media distribution system under the replacement media contract,
wherein said updating changes a contract state stored in the database.

8. A computer-implemented method as recited in claim 7, wherein said method further comprises:
notifying, subsequent to said updating or said enabling, the media content provider that they are eligible to submit content to the media distribution system under the replacement media contract.

9. A computer-implemented method as recited in claim 7, wherein said enabling is dependent on receiving an approval of the personalized document set of the replacement media contract.

10. A computer-implemented method as recited in claim 1 further comprising:
notifying the media content provider to replace the at least one prior existing media contract with the replacement media contract.

11. A computer-implemented method as recited in claim 10,
wherein the replacement media contract is a replacement media contract version that is more recent than a version of the at least one prior existing media contract, and
wherein the notifying the media content provider to replace the at least one prior existing media contract with the replacement media contract comprises notifying the media content provider of availability of the replacement media contract version to replace the at least one prior existing media contract.

12. A computer-implemented method as recited in claim 1 further comprising:
notifying the media content provider to replace the at least one prior existing media contract with the replacement media contract within a predetermined time period, and
notifying the media content provider that continued submission of media content by the media content provider to the media distribution system is prevented when the at least one prior existing media contract is not replaced with the replacement media contract within the predetermined time period.

13. A computer-implemented method as recited in claim 11,
wherein the scope of agreement of the at least one prior existing media contract covers a first type of media content, and
wherein the scope of agreement of the replacement media contract covers a second type of media content in addition to the first type of media content.

14. A computer-implemented method as recited in claim 1,
wherein the first scope of agreement of the at least one prior existing media contract covers a first geographic region, and
wherein the scope of agreement of the replacement media contract covers a second geographic region in addition to the first geographic region.

15. A computer-implemented method as recited in claim 1,
wherein the storing comprises storing at least (i) a first prior existing media contract having a first scope of agreement and (ii) a second prior media existing contract having a second scope of agreement in the database,
wherein the scope of agreement of the replacement media contract is expanded beyond not only the first scope of agreement of the first prior existing media contract but also the second scope of agreement of the second prior existing media contract, and
wherein the replacement media contract serves to replace both the first prior existing media contract and the second prior existing media contract.

16. A computer-implemented method as recited in claim 15,
wherein the scope of agreement of the first prior existing media contract covers a first type of media content,
wherein the scope of agreement of the second prior existing media contract covers a second type of media content, and
wherein the scope of agreement of the replacement media contract covers the second type of media content in addition to the first type of media content.

17. A computer-implemented method as recited in claim 15,
wherein the first scope of agreement of the at least one prior existing media contract covers a first geographic region, and
wherein the second scope of agreement of the at least one prior existing media contract covers a second geographic region, and wherein the scope of agreement of the replacement media contract covers the second geographic region in addition to the first geographic region.

18. A media management system for managing distribution of media content, said media management system comprising:
an agreement management system performed by at least one computing device, the agreement management system being configured to manage media distribution agreements, store agreement information of the media distribution agreements in a database, determine whether to replace at least one prior existing media distribution agreement with a replacement media distribution agreement, the replacement media distribution agreement being for a media content provider and having a scope of agreement that is expanded beyond that of the at least one prior existing media distribution agreement being replaced, and dynamically and automatically personalize the replacement media distribution agreement for the media content provider; and
a media distribution system coupled to the agreement management system that manages electronic distribution of media content associated with media content providers to purchasers over a network.

19. A media management system as recited in claim 18, wherein the scope of the agreement of the replacement media distribution agreement is expanded with respect to types of media content covered.

20. A media management system as recited in claim 18, wherein the replacement media distribution agreement supports at least one additional type of media content as compared to the one or more types of media content supported by the at least one prior existing media distribution agreement.

21. A media management system as recited in claim 18, wherein the scope of the agreement of the replacement media distribution agreement is expanded with respect to geographic regions covered.

22. A media management system as recited in claim 18, wherein the replacement media distribution agreement supports at least one additional geographical region as compared to the one or more geographic regions supported by the at least one prior existing media distribution agreement.

23. A media management system as recited in claim 18, wherein said agreement management system comprises a notification manager configured to notify media content providers with prior existing media distribution agreements to replace prior existing media distribution agreements with replacement media distribution agreements.

24. A media management system as recited in claim 23, wherein the notification manager is configured to notify media content providers with prior existing media distribution agreements to replace prior existing media distribution agreements with replacement media distribution agreements which represent more recent versions than versions of the prior existing media distribution agreements.

25. A media management system as recited in claim 18, wherein said agreement management system is configured to replace a first prior existing media distribution agreement covering a first geographic scope of agreement and a second prior existing media distribution agreements covering a second geographic scope of agreement with the replacement media distribution agreement covering at least the first and second geographic scopes of agreement.

26. A media management system as recited in claim 18, wherein said agreement management system is configured to replace a first prior existing media distribution agreement covering a first type of media content and a second prior existing media distribution agreements covering a second type of media content with the replacement media distribution agreement covering at least the first and second types of media content.

27. A non-transitory computer readable medium including at least computer program code stored on thereon for processing of media distribution agreements between a media content provider and a media distribution system, said computer readable medium comprising:
computer program code for receiving an agreement replacement request from a media content provider to replace first and second prior existing media distribution agreements with a replacement media distribution agreement;
computer program code for determining the replacement media distribution agreement to be utilized for the agreement replacement request;
computer program code for personalizing the replacement media distribution agreement for the media content provider; and
computer program code for providing the personalized replacement media distribution agreement to the media content provider.
